(19) United States
(12) Patent Application Publication
(10) Pub. No.: US 2013/0249909 A1
(43) Pub. Date: Sep. 26, 2013

(54) METHOD FOR LARGE SCALE, NON-REVERTING AND DISTRIBUTED SPATIAL ESTIMATION

(71) Applicants: Paul Thompson, Burwood (AU); Eric Nettleton, Kellyville (AU); Hugh Durrant-Whyte, Rozelle (AU)

(72) Inventors: Paul Thompson, Burwood (AU); Eric Nettleton, Kellyville (AU); Hugh Durrant-Whyte, Rozelle (AU)

(21) Appl. No.: 13/824,327

(22) PCT Filed: Oct. 21, 2011
(86) PCT No.: PCT/AU2011/001342

§ 371 Date: May 29, 2013

(30) Foreign Application Priority Data
Oct. 22, 2010 (AU) 2010904722

(51) Int. Cl. G06T 17/05

(52) U.S. Cl. CPC G06T 17/05
USPC 345/420

(57) ABSTRACT

Described herein is a system and a method of spatial field estimation from input data from a domain of interest. The method comprises defining a spatial mesh of positions over the domain of interest (802) and defining a smoothness information model (804) which is defined with respect to the spatial mesh to form an information matrix Y1 and vector y1. The method further comprises defining an information representation of the input data, the information representation comprising an information matrix Y_{obs} and vector y, both defined relative to the spatial mesh. The method further comprises through an additive function fusing (806) the smoothness information model with the information representation of the input data to form an information matrix Y and vector y. The method then comprises, in a computational system, solving for x in Yx=y (808), wherein x represents the spatial field estimation.

### FIELD OF THE INVENTION

This invention generally relates to the field of large scale spatial field estimation. Examples of particular applications include, but are not limited to, mining, environmental sciences, hydrology, economics and robotics.

### BACKGROUND OF THE INVENTION

In a large scale environment, like an open-cut mine, spatial modelling of geography and geology can have many uses in planning, analysis and operations within the environment. For example, an in-ground geological model of the ore body can be used to determine drilling, blasting and excavation operations, whilst a geographical model or terrain map can be used to monitor the status and progress of the mine. Furthermore, in the case of automated mining, a geographical model or terrain map can be used to guide robotic vehicles. A digital representation of the operating environment in the form of a spatial model is typically generated from sensor measurements which provide a sample of the actual environmental variable being modelled (e.g. elevation in the case of a terrain map, or ore grade in the case of in-ground ore body modelling) at various spatially distinct locations within the operating environment. The measured sample data is then treated in some manner such as by interpolation to determine information about the environment in locations other than those actually measured. Some of the challenges posed by this task include dealing with the issues of uncertainty, incompleteness and handling potentially large measurement data sets. The system which performs the spatial field estimation can be referred to as the picture compilation (PC) system. In a mining application it can be referred to as the mine picture compilation (MPC) system.

One of the problems with implementing a system using automated vehicles is the difficulty of creating large scale consistent, integrated maps which can provide information for completely automated vehicles so that they are able to safely travel and work in the terrain. Large scale integrated maps are often built using information sourced in a distributed manner from a large number of sensors and data sources. Terrain estimation is the process of estimating an underlying terrain surface given observations of the terrain that may be noisy, irregular and incomplete. The need for a distributed system for the terrain estimation is motivated by the fact that the platforms which acquire observations and platforms which need the estimates may themselves be physically distributed. Terrain observations in the context of a mine may be acquired by a physically distributed system consisting of both dedicated sensor vehicles and sensors on a wide variety of other platforms such as trucks, excavators and fixed installations. Additional terrain observations may be taken by human surveyors. The estimated terrain model may need to be available to a distributed system, such as locally on vehicles, on mid and higher level autonomous vehicles and available to human controllers and supervisors.

One known terrain modelling formulation uses a Gaussian process (GP) method, modelled using dense covariance functions. A dense covariance matrix is one where all entries are non-zero. The term “GP Covariance method” will be used herein for a Gaussian process that uses covariance functions.

Whilst the GP Covariance method is a useful and powerful tool for regression in supervised machine learning it is regarded as a computationally expensive technique, which is particularly disadvantageous in the treatment of large measurement data sets. The computational expense is primarily brought on by the need to invert a large covariance matrix during the inference procedure. For problems with thousands of observations, exact inference in the normal GP Covariance method is intractable and approximation algorithms are required.

There remains a need for improved methods of spatial field estimation so that large scale data can be modelled. The invention is described with particular reference to the application of mining, in particular the application of forming an estimate of the terrain or underground properties of the mine from a set of observations. A spatial field estimate may have application to mining operations, either autonomous or conventional. However, the present invention has more general application. The invention may have particular utility in spatial field estimation when there are a larger number of observations (or other inputs) than the number of output points required on the estimation.

### SUMMARY OF THE INVENTION

The invention generally relates to spatial field estimation by defining observed data as an information representation relative to a spatial mesh of positions over the domain of interest. The estimation may be non-reverting to a mean or zero value in locations of low density or no observations.

In some embodiments, the information representation is fused with a smoothness information model defined with respect to the same spatial mesh. The resulting fused information representation is then solved to provide the spatial field estimate. A covariance of the spatial field estimate can also be computed. Through use of the fused information model, the estimate is non-reverting or in other words in areas of low density or no observations the estimate does not revert to zero or a mean.

Where additional observed data is to be added to the spatial field estimate, then this is achieved by defining the additional observed data as an information representation relative to the same spatial mesh and fusing the additional observed data with the previous observed data and the smoothness information model. This modified fused information representation is then solved for the spatial field estimate.

In some embodiments, each grid position is associated with a combination of discrete trial functions with variable coefficients. The observed data is then mapped to the grid positions by said coefficients.

The smoothness information model may defined independently of the spatial field observations. Accordingly, the smoothness information model and the spatial mesh may be predefined in a computational system. The smoothness information model may include one or both of slope (also known as gradient or first derivative) and curvature terms.

In other embodiments, pseudo data elements are included with the observed data where there is low density or no observations. The pseudo data elements are then incorporated into the information model.

In one aspect the invention provides a method of spatial field estimation from input data from a domain of interest, the method comprising: defining an information representation of the input data, the information representation comprising an information matrix Yobs and vector y, both defined relative to a spatial mesh of positions over the domain of interest; through an additive function fusing the information matrix, Yobs with a smoothness information model defined with respect to the spatial mesh to form an information matrix Y; in a computational system solving Yx=y, wherein x represents the spatial field estimation.

In another aspect the invention provides a method of spatial field estimation from input data from a domain of interest, the method comprising: defining a spatial mesh of positions over the domain of interest; defining a smoothness information model defined with respect to the spatial mesh to form an information matrix Y1 and vector y1; defining an information representation of the input data, the information representation comprising an information matrix Yobs and vector y, both defined relative to the spatial mesh; through an additive function fusing the smoothness information model with the information representation of the input data to form an information matrix Y and vector y; in a computational system solving for x in Yx=y, wherein x represents the spatial field estimation.

In another aspect the invention provides a method of spatial field estimation of a domain of interest, the method comprising: defining a first information representation of first input data representative of the domain of interest, the first information representation comprising an information matrix Y_{obsA} and vector yₐ, both defined relative to a spatial mesh of positions over the domain of interest; receiving further input data; defining a further information representation, the information representation comprising an information matrix Y_{obsB} and vector y_{b}, both defined relative to the spatial mesh of positions over the domain of interest; performing an additive function of the further information representation with the first information representation and a smoothness information model to provide a fused information representation, the fused information representation comprising information matrix Y and vector y; in a computational system solving Yx=y, wherein x represents the spatial field.

In another aspect there is provided a method of spatial field estimation from input data from a domain of interest, the method comprising: receiving input data; defining an information representation of the input data, the information representation comprising an information matrix Y and vector y, both defined relative to a spatial mesh of positions over the domain of interest; in a computational system solving Yx=y, wherein x represents the spatial field estimation; wherein the method further comprises: modifying at least one of the input data and the information representation of the input data so that the solution to Yx=y does not revert to zero or the mean in regions of low or no input data.

The invention also generally relates to a computational system for performing spatial field estimation as described above. The computational system may have distributed components, with different components acting on different sets of observed data. The information models of the observed data are combinable, which may for example facilitate formation of a global picture from distributed sensing systems.

In one aspect the invention provides a computational system comprising a processor and instructions in memory that, when executed by the processor, cause the processor to compute a spatial field estimation based on input data according to the methods described above.

In another aspect the invention provides a distributed computational system comprising a plurality of data processors, each in communication with memory comprising instructions that, when executed, cause that data processor to compute a spatial field estimation based on input data according to the methods described above.

In another aspect the invention provides a non-transient computer program product comprising computer readable instructions, the instructions comprising: instructions for defining an information representation of input data, the information representation comprising an information matrix Yobs and vector y, both defined relative to a spatial mesh of positions over a domain of interest; instructions for performing an additive function to fuse the information matrix Yobs with a smoothness information model defined with respect to the spatial mesh to form an information matrix Y; instructions for solving Yx=y, wherein x represents the a spatial field estimation.

In another aspect the invention provides a non-transient computer program product comprising computer readable instructions, the instructions comprising: instructions for receiving and storing input data; instructions for defining an information representation of the input data, the information representation comprising an information matrix Y and vector y, both defined relative to a spatial mesh of positions over the domain of interest; instructions for solving Yx=y, wherein x represents a spatial field estimation; instructions for modifying at least one of the input data and the information representation of the input data so that the solution to Yx=y does not revert to zero or the mean in regions of low or no input data.

### BRIEF DESCRIPTION OF THE DRAWINGS

FIG. 1 is an example of a computing system utilizable to implement a mine picture compilation (MPC) system.

FIG. 2A is a diagrammatic illustration of a terrain region and a system adapted for generating and maintaining a Corresponding spatial field estimate.

FIG. 2B shows a mine sensing vehicle fitted with a terrain scanning sensor.

FIG. 3 is a schematic representation of a mine picture compilation (MPC) system.

FIG. 4A is a schematic representation of a distributed MPC architecture with a centralized architecture.

FIG. 4B is a schematic representation of a distributed MPC architecture with an unbalanced distribution topology.

FIG. 4C is a schematic representation of a distributed MPC architecture with a disconnected non-sharing architecture'.

FIG. 5 is a schematic representation of a balanced distributed MPC network topology.

FIG. 6 is a schematic representation of the distributed MPC system of FIG. 5.

FIG. 7 is an example of a function expressed in the trial functions basis.

FIG. 8 is a diagrammatic representation of the method steps used to obtain an estimate.

FIG. 9A is an example of a mesh layout with identical 1×1 cells.

FIG. 9B is an example of a mesh layout with alternating 1×1 cells.

FIG. 9C is an example of a mesh layout with an hexagonal grid layout.

FIG. 9D is an example of a mesh layout with a circular mesh.

FIG. 10A illustrates a representation of the terrain surface within a linear triangular element.

FIG. 10B illustrates a representation of the terrain surface within a quadratic triangular element.

FIG. 11 shows diagrammatic representations of how observations are related to states.

FIG. 11A is a diagram showing the relationship between, observations and evaluation states in conventional estimation.

FIG. 11B is a diagram showing the relationship between observations and evaluation states using the GP Covariance method where an observation is close to an existing evaluation state.

FIG. 11C is a diagram showing the relationship between observations and evaluation states using the GP Covariance method where an observation is not close to an evaluation state.

FIG. 12A is a diagram of a triangularised spatial mesh model shown without any observations.

FIG. 12B is a diagram of the fusion of observations into the triangularised mesh model of FIG. 12A.

FIG. 12C is a diagram of the spatial mesh model of FIG. 12A including observations over the whole region.

FIG. 12D is a diagram of an inner subset region of the spatial mesh model shown in FIG. 12A.

FIG. 13 shows an example of estimation results obtained using a GP Information method where the raw observations were sourced from two lasers and a GPS.

FIG. 13A is a Delaunay based triangulation surface of benches in the example of the Tom Price mine, using GPS data only.

FIG. 13B is a Delaunay based triangulation surface of the benches shown in FIG. 13A from laser data only.

FIG. 13C is the output of a GP Information method for the benches shown in FIGS. 13A and 13B.

FIG. 14 shows an example of estimation results, obtained using a GP Information method.

FIG. 14A shows the estimate output from the GP Information method.

FIG. 14B shows a GP Information estimate, showing the internal mesh.

FIG. 14C shows the GP Information model estimate, showing the observations.

FIG. 15 shows broader area views comparing the raw observation Delaunay meshes and GP Information output for the same example illustrated in FIGS. 13 and 14.

FIG. 15A shows a Delaunay based triangulation surface of a broader area view of the Tom Price mine from GPS data only.

FIG. 15B shows a Delaunay based triangulation surface of the area shown in FIG. 15A using laser data only.

FIG. 15C shows the output from the GP Information method for the area shown in FIG. 15A and 15B.

FIG. 16 is a graph of datasizes plotted as a function of the number of datasets included for total information, fused observations, the fused observation information matrices (Y_{obs i}) and raw observations.

FIG. 17 is a graph of datasizes plotted as a function of the number of datasets included for total information, fused observations and the fused observation information matrices (Y_{obs i}) only.

FIG. 18 is a diagram of an alternative method according to an embodiment of the invention.

### DETAILED DESCRIPTION OF THE EMBODIMENTS

In mining broad top-level maps may be required and in addition there may be a requirement for fast ‘local space fusion’. A top-level map means a broad scale, high quality, globally consistent map, which may be built from as much sensor data as possible. Local space fusion means allowing local units e.g. vehicles or mobile sensor devices to quickly sense and update local maps, optionally in real-time, and then share these updates through local links to picture compilation nodes. Providing a hierarchy to the mine picture compilation system allows this blend of fast, local operation as well as broad scale, quality terrain mapping.

The distributed system described herein facilitates the creation of both top level maps and local space fusion. Distributed sensing and estimation means that spatial field observations and measurements are fused locally and communicated through a distributed network. Thus many distributed sensor sources can be consistently fused into a single mine picture. Efficient distributed sensing and estimation is achieved by using the information form (also called the inverse covariance form) which has simple and efficient algorithms for fusion of multiple sensor datasets. This enables distributed operation because of the reduced communications load for transmission of the fused results. Larger scale consistent estimation means that observations from a broad area are used to simultaneously estimate a broad area of terrain, without discontinuities in the estimated surface, rather than in small disconnected patches. Efficient larger scale consistent estimation is achieved by using the GP Information method together with sparse information smoothing models for the terrain. The sparsity allows larger area simultaneous terrain estimation.

The GP Information method described below addresses the need to obtain a solution in regions where there are no observations or a low density of observations by modelling the terrain prior information using differential operators, which are able to impose terrain smoothness without causing the terrain, elevation to revert to the mean or zero, which may introduce some error. This model extends Gaussian processes in the covariance form, the GP Covariance method, to enable efficient distributed sensing and estimation, and larger scale consistent and non-reverting estimation.

Non-reverting estimation means that, the terrain estimates do not revert to the mean (or zero). In contrast, when regression is used in the GP Covariance method, then for some covariance functions terrain estimates tend to return to the mean (or zero) in more uncertain regions. The information modelling approach proposed herein provides a solution by modelling the terrain prior information using differential operators, which are able to impose terrain smoothness without causing the terrain elevation to be biased or to revert to the mean or zero.

### 1. System Overview

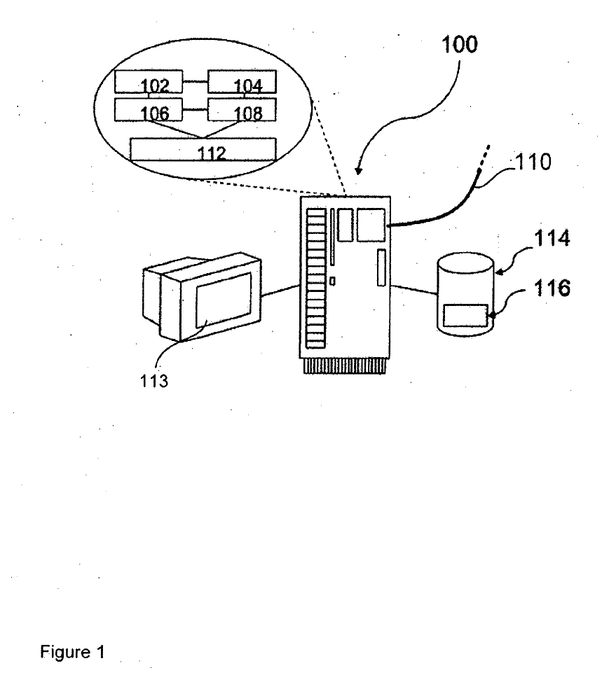

Referring to FIG. 1, an embodiment of an MPC system is implemented with the aid of appropriate computer hardware and software in the form of a computing system 100. The computing system 100 comprises suitable components necessary to receive, store and execute appropriate computer instructions. The components may include a processing unit 102, non-transient memory such as read only memory (ROM) 104 or a CD ROM, random access memory (RAM) 106, an input/output device such as disk drives 108, communication links 110 such as an Ethernet port, a USB port, etc, and a display 113 such as a video display or any other suitable display. The computing system 100 includes instructions that may be included in ROM 104, RAM 106 or disk drives 108 and may be executed by the processing unit 102. There may be provided a plurality of communication links 110 which may variously connect to one or more computing devices (for example to form a distributed system) such as a server, personal computers, terminals, wireless handheld computing devices or other devices capable of receiving and/or sending electronic information.

In one embodiment remote terminals forming part of a distributed system may be housed on mobile sensor units and may be used for local space fusion. The remote terminals may also include storage devices such as a hard disk drive or optical drive.

At least one of a plurality of communications links may be connected to an external computing network through a telephone line, an Ethernet connection, wireless link or any other type of communications link. Additional information may be entered into the computing system by way of other suitable input devices such as, but not limited to, a keyboard and/or mouse (not shown).

The computing system may include storage devices such as a disk drive 108 which may encompass solid state drives, hard disk drives, optical drives or magnetic tape drives. The computing system 100 may use a single disk drive or multiple disk drives. A suitable operating system 112 resides on the disk drive or in the ROM of the computing system 100 and cooperates with the hardware to provide an environment in which software applications can be executed.

In particular, the data storage system is arranged to store measurement data received from the sensors, in a suitable database structure 114. The data storage system also includes a terrain model 116, which is utilised with the measurement data to provide a 2.5D “map” of the terrain. The data storage system may be integral with the computing system, or it may be a physically separate system.

In more detail, the data storage system is loaded with a modelling module including various sub-modules. The sub-modules are arranged to interact with the hardware of the computing system 100, via the operating system 116, to receive the data collected by the measurement sensors (generally sent via the communications links 114), to receive data resulting from local space fusion from distributed terminals and/or process the received data to provide the measured data. In some embodiments, there may be provided a visual display unit, which may be in either local or remote communication with the computing system 100, and is arranged to display information relating to the programs being run thereon. In other embodiments, the data may be used directly by an autonomous robot (e.g. an automated vehicle) to perform particular tasks, such as navigation of the terrain.

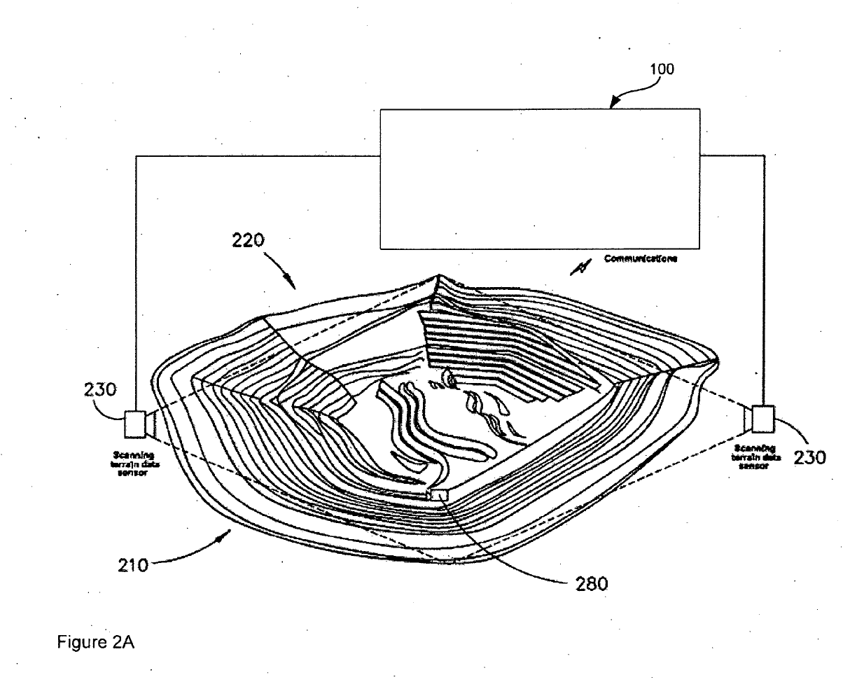

FIG. 2A is a diagrammatic illustration of a terrain region and a system adapted for generating and maintaining a corresponding spatial field estimate for generating a terrain map that may be used by autonomous vehicles. The MPC system 210 operates on a terrain region 220 in the form of an open pit mine, and utilises one or more measurement sensors 230 to provide measured terrain data about the region 220. The sensor 230 provides spatial data measured from the terrain region 220 which can be generated by a number of different methods, including laser scanning, radar scanning, GPS or manual survey. One example of an appropriate measurement sensor is the LMS Z420 time-of-flight laser scanner available from Riegl. This form of sensor can be used to scan the environment region and generate a 3D point cloud comprising (x, y, z) data in three frames of reference. In the system 210 illustrated, two separate scanners are shown disposed to opposite sides of the terrain to be modelled so as to minimise occlusions and the like.

In one embodiment the sensors may be disposed on mobile units as shown in FIG. 2B. The mine sensing vehicle 240 includes one or more terrain sensing scanners 242 as well as a navigation system (not shown), such as an Applanix POSLV 610 navigation system that may be used to automate the registration of the data. On-board processing and communications equipment may also be used to integrate the data directly into the MPC geometry model.

### 2. Distributed System Application

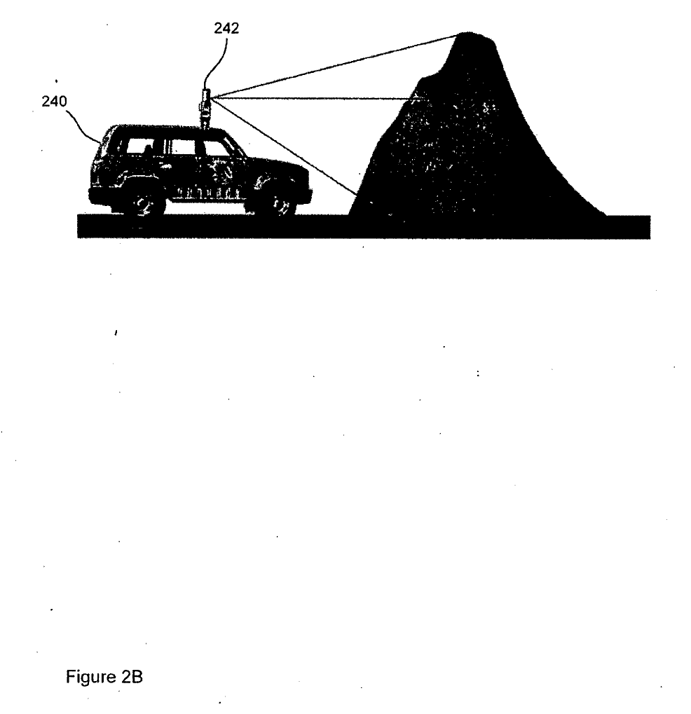

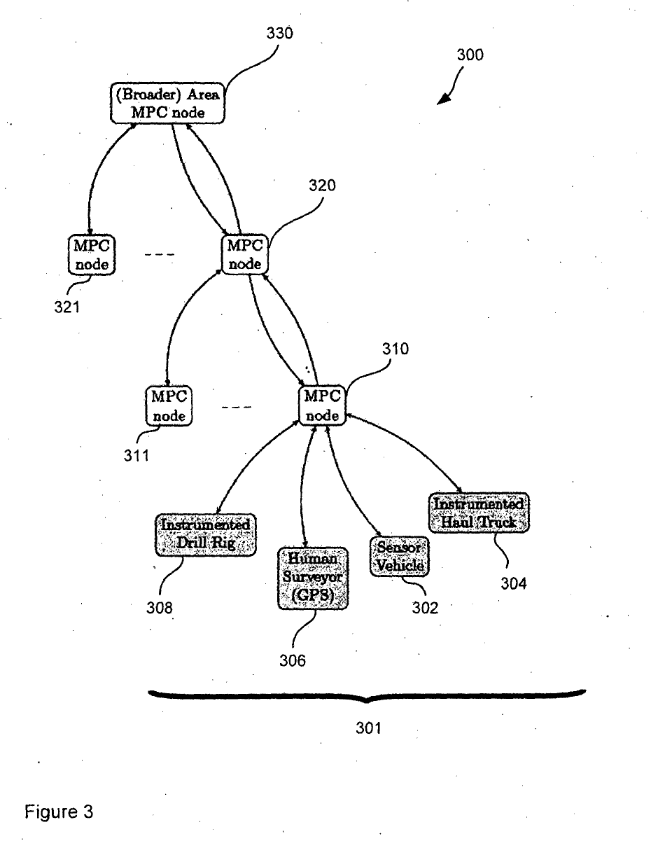

One embodiment of the invention is a distributed mine picture compilation (MPC) system, as shown in FIG. 3.

A distributed system for the terrain estimation is useful in the context of a mine because the platforms which acquire the observations and the platforms which need the estimates are themselves physically distributed. Terrain observations are acquired by a physically distributed system which may consist of both dedicated sensor vehicles and sensors on a wide variety of platforms such as trucks, excavators, fixed installations and human surveyors. The estimated terrain models can be used by a distributed system, such as locally on vehicles, on mid and higher level autonomous and human controllers and supervisors. The need for a distributed system is also motivated by communication constraints.

FIG. 3 shows an exemplary distributed mine picture compilation (MPC) system 300, upon which the present invention can be implemented. The arrows show information flow between each physical platform (330, 321, 320, 311, 310, 304, 302, 306, 308) in the system. Each platform comprises an information processor with communication means, memory and a power source for powering the information processor (not shown). The communication means comprises means for receiving and transmitting information e.g. via a radio receiver and transmitter.

The distributed mine picture compilation system is composed hierarchically, consisting of a number of nested or overlaid areas or islands (310, 320, 330). Each island covers an area which is a subset of, or equal to its parent island. For example island 310 covers sensors 304, 302, 306, 308. Island 311 covers a similar number of sensors (not shown). Parent island 320 communicates with islands 310 and 311 and accordingly parent island 320 covers the area of 310 and 311 combined.

In other embodiments, the distributed mine picture compilation system can be composed of a pattern of partially overlapping areas or islands.

Individual sensor sources 301 contribute information in a distributed manner up the hierarchy to local island controller 310, which in turn contributes information up to area island controllers 320 which in turn contribute information to central top level MPC controllers 330. Individual sensor sources may consist of dedicated sensor vehicles 302, instrumented mine vehicles 304, fixed platform sensors 308 as well as surveyors and human operated sensors 306. The sensor sources 301 include a sensor system to scan the terrain as well as localisation sensors (such as GPS) to sense their location. An example of a suitable sensor for scanning the terrain is the RIEGL LMS-Z620 which is a 3D laser scanner with high laser repetition rate, fast signal processing and a high speed data interface.

The individual sensor sources may further include an information processor which controls the sensor and receives pre-processed data. The information processor then processes the information to obtain observations. The sensor source further includes communication means for communicating with other platforms.

A picture compilation platform for a parent island (e.g. 320) sends mesh definitions as well as spatial downlink information to the child platform (e.g. 310). A child platform sends uplink spatial information to its parent platform.

In some embodiments, the spatial downlink information consists of an exact or approximate marginal for the child subset region. This marginal information allows the child platform to achieve global-equivalent estimates by adding the marginal to local fused observations. An exact marginal includes all fused information for the child subset area from the parent, including the effect of observations occurring nearby but outside the child area. An approximate marginal is any approximation to the exact marginal, for example, the fused information from observations occurring only in the child area.

In other embodiments, the spatial downlink information consists of any literal observations in the child area, which the parent picture compilation platform sends to the child picture compilation platform.

For the uplink from a child platform to a parent platform, in some embodiments the uplink spatial information consists of fused observation information. In other embodiments the uplink spatial information consists of literal observations.

This system architecture uses two capabilities of the GP Information method namely:
1. The ability to perform distributed fusion of the terrain model. This is useful because the transmission of information consists of a posterior map resulting from the fusion of many observations (with the resulting reduction in data size), and the reception of such information requires fusion to incorporate it into larger maps.
2. The ability to perform solving of the model on a local level. This is also known as “local space fusion”. This is useful because it gives local platforms the ability to quickly update and estimate a local map, rather than needing a higher level MPC node to perform the map estimation.

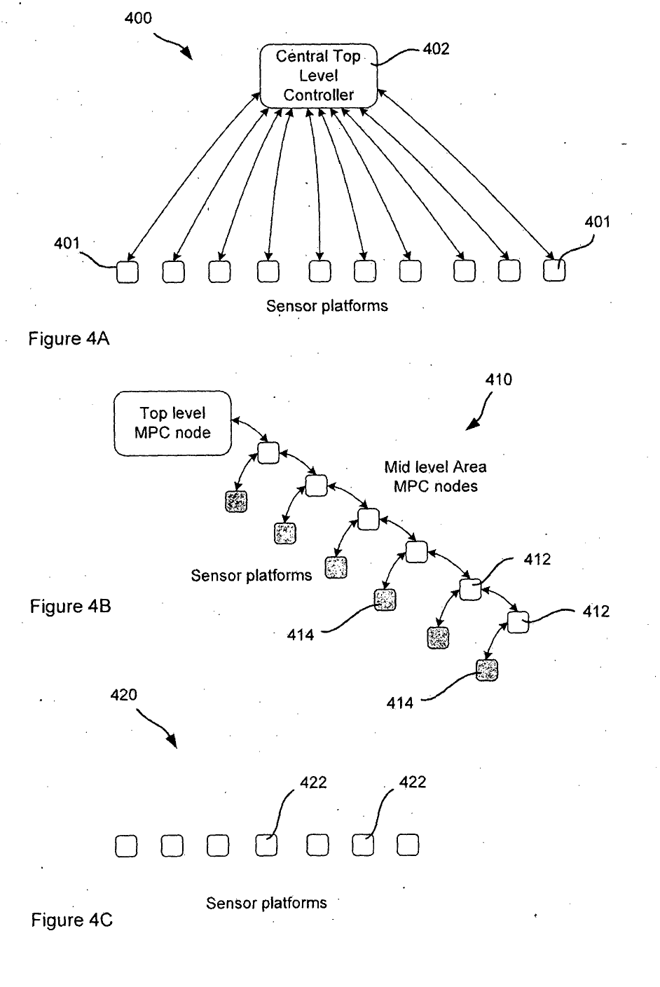

The GP Information method could also be implemented using different distributed architectures, such as those shown in FIG. 4, FIG. 4A shows distributed MPC architecture with a centralised (“single-level” or “large fan-in”) architecture 400 in which all sensor platforms 401 communicate directly with a single fusion centre 402. FIG. 4B shows a distributed MPC architecture with an unbalanced distribution topology 410 with many intermediate MPC nodes 412 in proportion to the number of sensor platforms 414. FIG. 4C shows a distributed MPC architecture with a disconnected non-sharing architecture 420, in which sensor platforms 422 operate independently, acquiring their own sensor data and building maps as required. In this embodiment, sensor platforms would not require communication means.

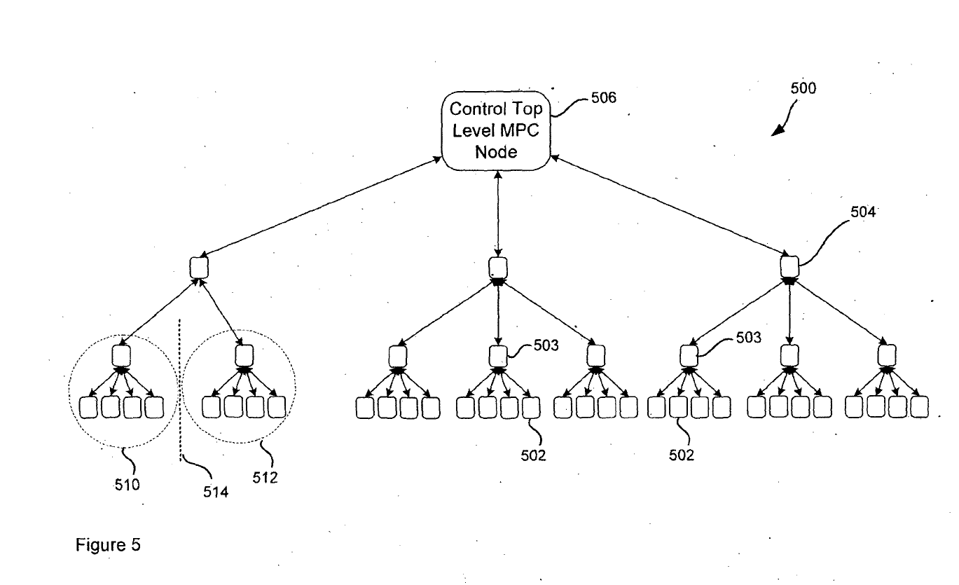

In other embodiments, the architecture is a balanced distributed topology 500 as shown in FIG. 5. It has a roughly constant fan-in of links at each level. Sensor platforms 502 communicate only locally to a nearby MPC node 503. This first level of MPC nodes 503 then communicates to a second level of MPC nodes 504 that in turn communicates with the top level MPC node 506. The number of levels in the hierarchy may differ and may depend, for example, on the size and complexity of the whole system.

Because the sensor platforms 502 communicate only locally to a nearby MPC node 503, this means:
sensor platforms 502 have fast access to a local MPC node 503 and each MPC node only has a small number of active connections, as opposed to the architecture shown in FIG. 4A which would require platforms 401 to communicate with a distant, global MPC fusion centre 402, and the global MPC 402 to have a large number of connections to sensor platforms 401.
there is a fairly short sequence of paths from the lowest sensor platforms 502 to the top level MPC node 506, and there is a relatively small ratio of first level MPC nodes 503 to sensor platforms 502.

### 2.1. Robustness Against Sensor, MPC Node and Communications Failures.

Taking the embodiment of a distributed architecture as shown in FIG. 5, this architecture is robust against individual sensor failures. The remaining network would lose the contribution of the failed sensor, but the contributions of other sensors and synchronisation across MPC nodes would still continue successfully. The robustness against MPC node or communications link failure depends on the network topology. Tree networks are advantageous in decentralised networks because of their simplicity for estimation and low communication bandwidth requirements. Although tree networks are not globally robust against node or communications link failure, the remaining connected components would still be able to function correctly, albeit with a loss of global consistency. So, for example, if a second level MPC node 504 connecting two large regions of operation 510, 512 were to fail, then the terrain estimates of the two regions at their border 514 would become unsynchronised, but they would be able to continue independently despite the reduction in performance.

### 2.2. Distributed of Information Models and Local Solving

The distributed operation relies on the fusion properties, especially the simple additive form for the fusion operations. The following are manipulations on the information representation that are performed for distribution:

### 2.2.1. Marginalisation

A marginal is a probabilistic equivalent of a subset of some other larger set of variables. Marginalisation means compressing a larger, joint probability distribution over a large region into a probability distribution over a smaller region. In the context of terrain models, information for a certain region is obtained not only through direct observations of that region, but also by nearby observations which correlate into the region from outside. Marginalisation means keeping the direct information inside the region (from observations) but also fusing in the information from outside into the representation of that region. Marginalisation is not the same as just taking the information from the observations which fall in that region. Marginalisation is not the same as taking the terrain surface estimate of a given region. The estimate on its own is not suitable for fusion of further observations or expressing the uncertainty in the estimate. The down-linking relationships shown in FIG. 3 send the marginal information from higher MPC nodes 320 down to lower MPC nodes 310. The operation of marginalisation is well defined but computationally non-trivial in the information form. However, along with the ease of fusion in the information form, it provides a useful tool for building distributed information systems.

The exact marginalisation requires the effect of observations outside the subset region to be effected within the variables of the subset region. This may result in an additional large number of nonzero entries to be included in the information matrix for the subset region. Therefore some embodiments use an approximation to the marginal which consists of a fusion of only those observations which lie in the subset region, excluding the effect of observations which are nearby but outside the subset region.

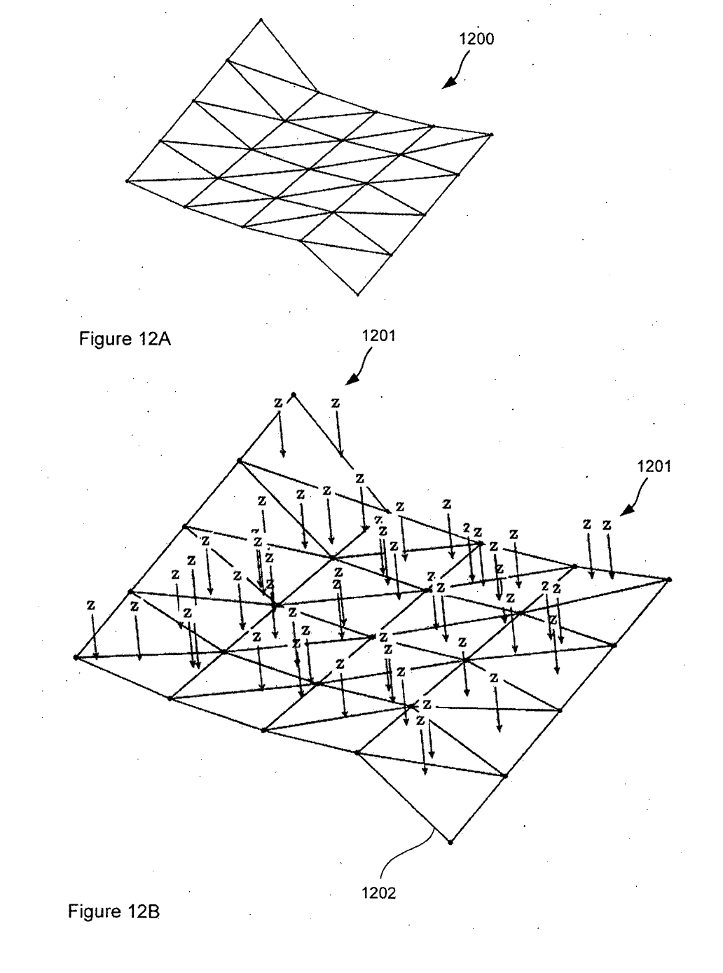

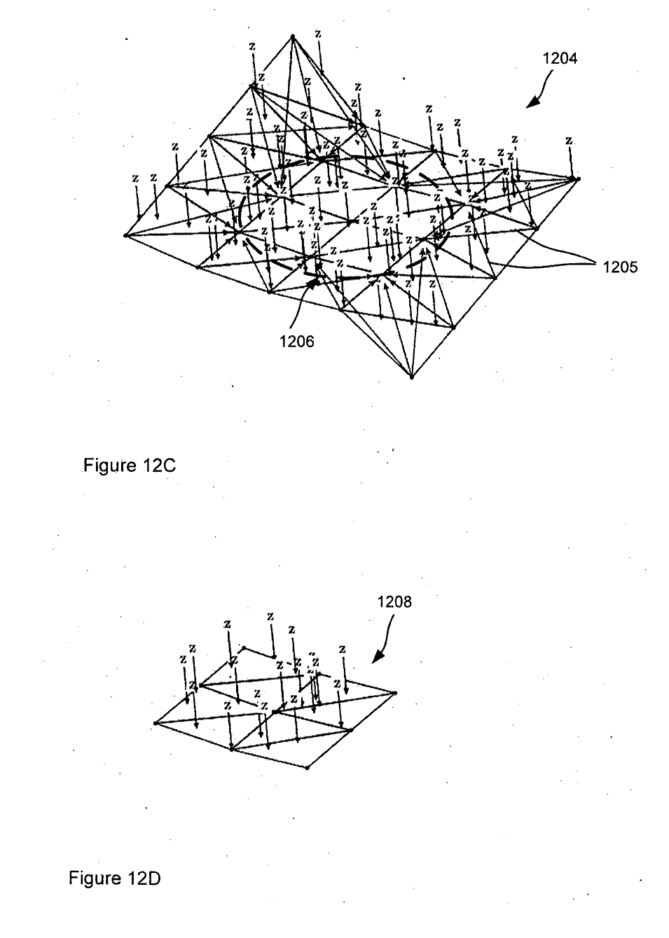

Referring to FIG. 12A a diagram of a triangularised spatial mesh model 1200 without any observations is shown. FIG. 12B is a diagram of the fusion of observations into the triangularised mesh model and FIG. 12C shows a mesh model 1204 including observations over the whole region showing the exact marginalisation into the inner subset region 1206. The arrows 1205 indicate how the outer area is removed so that the inner region 1206 remains. In another embodiment as shown in FIG. 12D an inner subset region 1208 of a spatial mesh model is shown with only the observations in the child region 1208. This is an approximation equivalent to the marginal for the inner subset region (as shown in FIG. 12C).

2.2.2. Fusion

This means the contribution of independent observations into a predefined mesh, and also being able to represent pure observation information (as independent information, not including terrain smoothness information).

2.2.3. Local Solving

Local solving means taking the marginal plus the fusion of local observations and solving this on a local level for immediate usage. Vehicles operating strictly in a controlled island or area need to be able to update their own immediate terrain information at high frequency, and update the island controller's terrain information at medium frequency. Fast terrain estimation can be ensured by exploiting their need for only locally consistent estimates.

2.2.4. Information Sharing

This is the process by which a sensor platform shares fused observations with higher controller nodes. This is the up-linking relationships shown in FIG. 3. This capability is a consequence of the additive fusion property in the GP Information formulation. Since the fusion of observations can be expressed as an information addition, it is easy to send partial sums of information through the network to achieve distributed information sharing.

The distributed MPC system may exploit the different needs at different parts of the system. At one extreme, locally correct, quickly updated estimates are needed at high speed, on individual vehicles and lower level MPC nodes without excessive computational capabilities. At the other extreme, high quality, broadly consistent global pictures on longer scales are required at higher level MPC nodes but with access to relatively more computational capabilities. This suits the hierarchical nature of the organisation of the system. In particular, individual platforms or MPC nodes will only ever need to represent and solve systems in proportion to their area of operation or responsibility. So platforms or MPC nodes operating within a small region only need small computational capabilities. But on the other hand, a large scale, globally estimated terrain model can still be accessed on the top level as a result of the distribution network. FIGS. 3 and 6 show the application of these distributed operations. FIG. 6 shows the breakdown of the global area MPC node 330 and operation of the distributed MPC system 300 by sharing marginals or approximate marginals of regions of the terrain between successive levels of the hierarchy. Individual sensor sources 301 contribute information in a distributed manner up the hierarchy to local MPC nodes 310, which in turn contribute information up to MPC nodes 320 of increasing scope. Downlinks to a given MPC node or platform from higher levels in the hierarchy send mesh definitions, as well as the information marginal for that node's operating region from the rest of the system. Such marginals allow the local node to achieve global-equivalent estimates from the local observations plus the received marginal. The uplink from a given node to a higher level node sends fused observation information. The regions do not have to be simple rectangles as shown in FIG. 6. The regions could be complex shapes such as the region of local roads, or the region of a local bench and face.

### 3. Method for Estimation of Spatial Fields

One embodiment of the present invention is a 2.5D terrain estimation formulation using a Gaussian process (GP) Information method.

### 3.1. Gaussian Process Information Form

Terrain estimation (also referred to as terrain modelling or geometry modelling) is the process of estimating an underlying terrain surface given noisy, irregular and/or incomplete observations of parts of the terrain. Described herein is a 2.5D terrain model. A 2.5D terrain model consists of a series of elevation (z) values (both observed and also to be estimated) at various positions (x,y).

Let the spatial estimate \hat{x} be a maximum probability estimate on a Gaussian probability density function, given some observations z=Hx+w with white noise w with covariance R, then:

$$p ( x \vert z ) = \frac{1}{C} exp ( - \frac{1}{2} {( z - Hx )}^{T} {R}^{- 1} ( z - Hx ) ) \\ \hat{x} = argmax p ( x \vert z ) \qquad Equation 1$$

This corresponds to seeking the minimum of F(x)=−log(p(x)), the negative log of the probability density. This then gives \hat{x} as the least squares estimate:

$$\hat{x} = argmin F ( x ) \\ \begin{matrix}F ( x ) = \frac{1}{2} {( z - Hx )}^{T} {R}^{- 1} ( z - Hx ) \\ = \frac{1}{2} {z}^{T} {R}^{- 1} x + \frac{1}{2} {x}^{T} {H}^{T} {R}^{- 1} Hx - {x}^{T} {H}^{T} {R}^{- 1} z\end{matrix} \qquad Equation 2$$

The optimal value of F(x) will be at a point x which has zero derivative:

$${\frac{\partial F ( x )}{\partial x} \vert}_{x = \hat{x}} = 0 \\ \frac{\partial F ( x )}{\partial x} = {H}^{T} {R}^{- 1} Hx - {H}^{T} {R}^{- 1} z \qquad Equation 3$$

Therefore the estimate \hat{x} is given by:

(H^{T}R⁻¹H)\hat{x}=H^{T}R⁻¹z Equation 4

If we define Y as H^{T}R⁻¹H and y as H^{T}R⁻¹z, then the condition for the solution is written as the GP Information form:

Y\hat{x}=y Equation 5

In order to account for observations falling in between evaluation points and to evaluate terrain estimates for points in between evaluation points the relevant surface may be represented as a series of functions instead of as a series of points. Points occupy no space and a representation using only paints makes no statements about the space in between the points. Instead with a series of functions a stretching between points is given by a linear combination of the functions. Estimation is then performed over the coefficients of these functions called trial functions. The representation using trial functions enables GP Information models on irregular, non-grid evaluation point patterns. The trial function representation approximates a solution function u(x) by a linear combination of trial functions φᵢ(x):

$$u ( x ) \approx {\sum }_{i = 1}^{N} {U}_{i} {φ}_{i} ( x ) . \qquad Equation 6$$

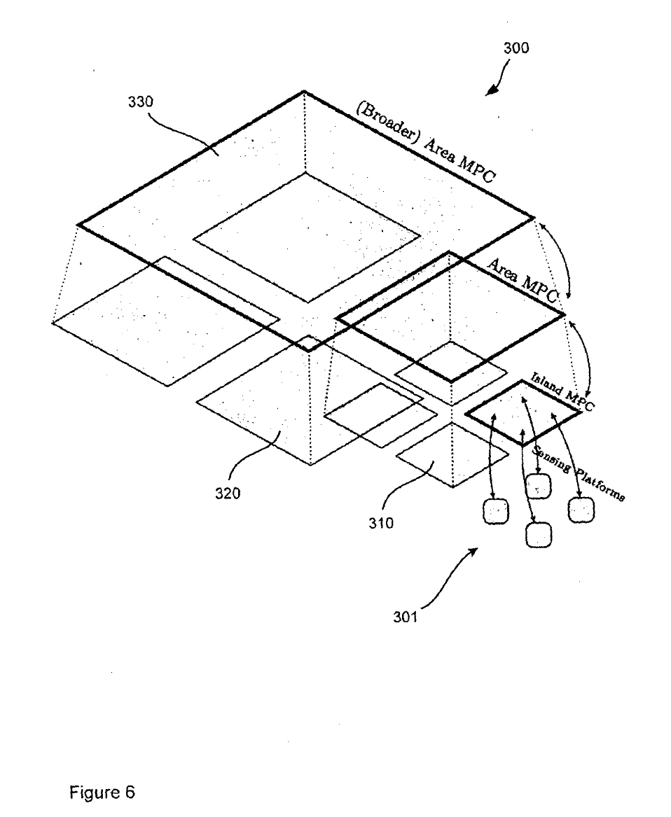

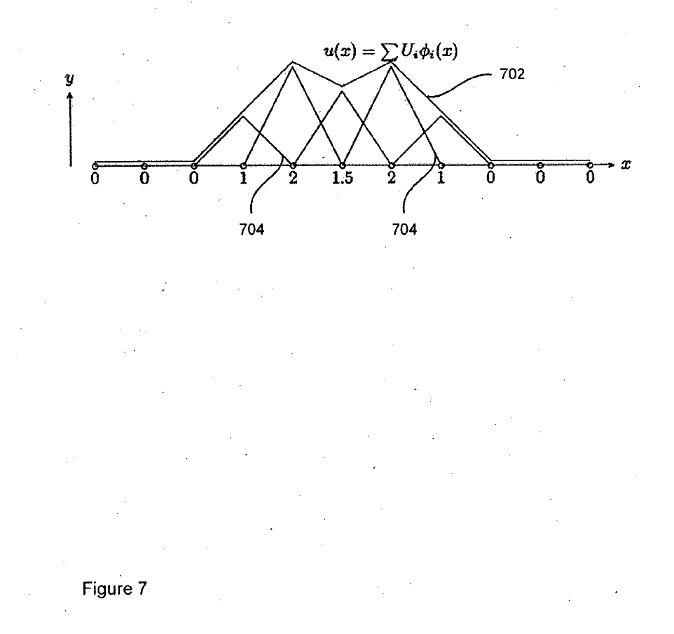

This is shown in FIG. 7 where the function u(x) 702 is expressed as a linear combination of the trial functions φᵢ(x) 704, by coefficients Uᵢ. The trial functions are selected so that the coefficients become the values of u(x) on the mesh nodes, but the values in between mesh nodes are also well defined.

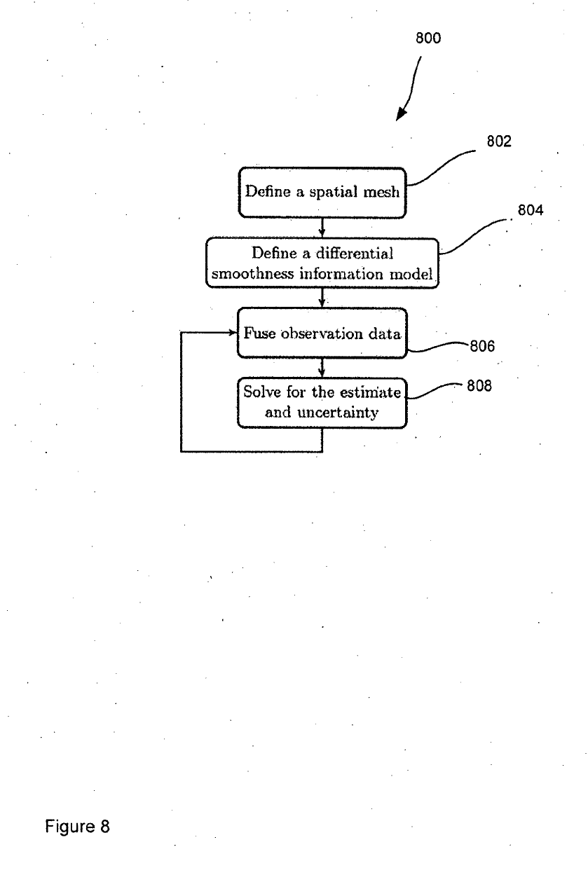

In a simple embodiment, the steps of the GP Information method 800 are as shown in FIG. 8:
1. Build the spatial mesh model (step 802).
2. Build the terrain smoothness prior information model (step 804).
3. Fuse observations into the information matrix and vector, for each observation, in each dataset (step 806).
4. Solve for the estimate and covariance (step 808).

3.2. Build the Spatial Mesh Model

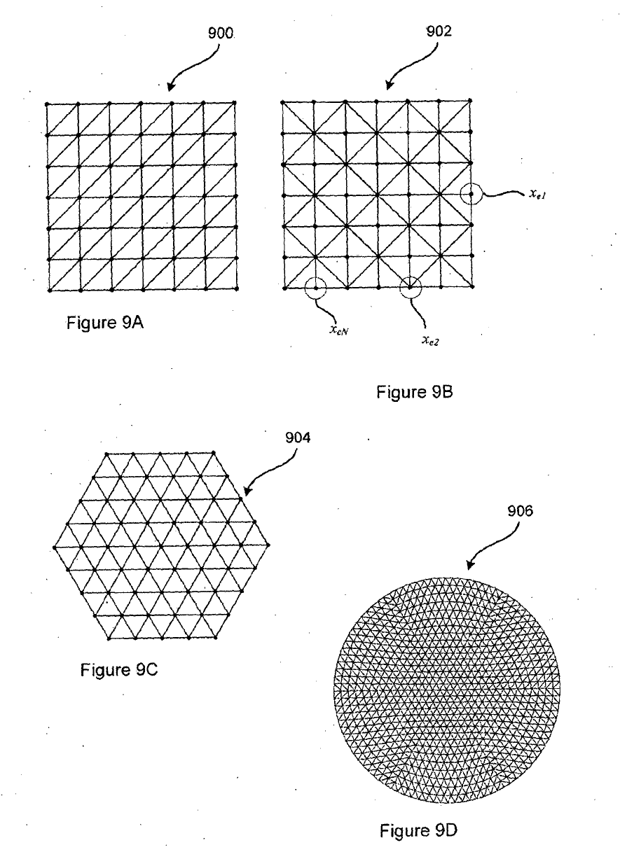

First, the spatial mesh is defined at step 802. The spatial mesh is a set of points in 2D space for which the terrain is estimated. In the GP Information method, the spatial mesh plays an active role as part of the representation and solution. Accordingly, the spatial mesh is established upfront in the method. FIG. 9 shows a number of non-limiting examples of mesh layouts that may be used. FIGS. 9A and 9B show regular triangulated grid mesh layouts. The regular grids are simple to define and give uniform spatial density. FIG. 9A shows a regular triangulated grid mesh 900 with identical 1×1 cells. FIG. 9B shows a regular triangulated grid mesh 902 with alternating 1×1 cells (or identical 2×2 cells). FIG. 9C shows an hexagonal grid system 904 which benefits from uniform equilateral elements and less pronounced corners than a square grid. FIG. 9D shows a circular mesh 906.

Practically, the choice of the spatial mesh depends on a tradeoff between terrain representation quality and computational speed. This is the same sort of tradeoff that engineers and programmers are accustomed to in fields such as finite element analysis and computer graphics. The spatial mesh can be chosen independently of the locations and density of the observations. This allows the mesh to be pre planned if desired. In one embodiment the spatial mesh is constructed from a regular grid of mesh points. So the spatial mesh can be defined simply by choosing the extent of the grid and the density of the grid. One approach is to choose a grid density of the same order of magnitude as the density of the observations. Alternatively, application specific knowledge can be used to decide on an appropriate grid density. Computational limitations can also dictate a maximum feasible density. For example, an ordinary computer workstation available at the time of filing of this patent application could operate with a grid of size up to about 10×10⁶ grid points. The spatial mesh can alternatively be a more complex triangulation mesh in general. For example, the spatial mesh could be a hierarchical quad-tree mesh which is able to focus the representation accuracy into specific regions (for example, known areas of mining operation and complex terrain) whilst avoiding mesh density in other regions (for example, unknown areas or far away regions).

Generally equations describing observation information are expressed as matrices and vectors (or more generally, probabilities) on some finite set of state variables. Those state variables are the xₑ spatial mesh points (i.e. the points which we wish to evaluate or estimate) as shown, for example, in FIG. 9B.

The spatial mesh helps to define the way information propagates in space. It helps to enable the sparsity of the terrain prior model and plays a role in enabling the fusion process. A GP Covariance method has unnecessary redundancy when an observation occurs close to an evaluation point. The GP Information method described herein exploits this property, removing the redundancy by relying on the links (terrain smoothness model) between evaluation points, so that observations can be expressed as sparse links to only a few local states, but still have a far reaching correlation effect on remote unobserved areas.

3.3. Terrain Smoothness Prior Information Model

At step 804 of the GP Information method the information matrix representation of the terrain smoothness prior information model is built. Terrain smoothness prior information model enables estimation of terrain in between observations and in empty unobserved regions and also ensures some smoothing among the observations to reduce noise. The terrain smoothness model is motivated by an a priori preference for smooth terrain estimates over rough terrain estimates. In the present embodiment, two types of smoothness model for the 2D terrain estimation are used, namely:

1. slope model.
2. curvature model.

Collectively, these are referred to as differential smoothness models to emphasise that they control the smoothness by affecting the first, second or higher derivative of the estimate. Mathematically, these are described by adding in information terms which assign more probability to terrain estimates which have small derivative and small curvature respectively.

The structure of these models is defined, depending only on the spatial mesh model. The magnitude of the smoothness information is a key terrain modelling parameter. In the presently described example, consisting of a regular grid for the spatial mesh; the terrain smoothness model is derived from finite difference representations for the gradients and curvatures of the terrain. A finite element approach may also be used to generate models for more general meshes, as described below.

In other embodiments, one or other (i.e. not both) of the slope model and the curvature model may be used to define the smoothness information model. In still other embodiments, higher order derivatives may also be incorporated into the smoothness information model.

3.3.1. Slope Model:

The slope model requires constructing Hₛₗₒₚₑ where Hₛₗₒₚₑ \hat{f} extracts a stacked vector of all the individual derivatives of the terrain surface f with respect to both X and y (where (x,y) are various positions on the grid) at each mesh point i:

$${H}_{slope} \hat{f} = {⋃}_{i} {[ \begin{matrix}\frac{\partial {f}_{s}}{\partial x} & \frac{\partial {f}_{i}}{\partial y}\end{matrix} ]}^{T} \qquad Equation 7$$

In the present embodiment, this uses a finite difference expression for the derivatives, based on a regular grid. For example, on a segment of terrain with elevations yₖ, xₖ and yₖ₊₁ at xₖ₊₁, the finite difference derivative is given by:

$$\frac{\partial y}{\partial x} \approx \frac{1}{h} {y}_{k + 1} - {y}_{k} \\ {H}_{slope} = \frac{1}{h} [ \begin{matrix}0 & … & - 1 & 1 & … & 0\end{matrix} ] \qquad Equation 8$$

Where h is the grid spacing, h=xₖ₊₁−xₖ.

Finally, the terrain smoothness information matrix is given by:

Yₛₗₒₚₑ=Hₛₗₒₚₑ^{T}Rₛₗₒₚₑ⁻¹Hₛₗₒₚₑ Equation 9

Where Rₛₗₒₚₑ is a model tuning parameter expressing the modelled covariance in the terrain slope. Rₛₗₒₚₑ is a control parameter for the model. Large Rₛₗₒₚₑ corresponds to very rough and steep terrain, small Rₛₗₒₚₑ corresponds to very flat terrain.

For general shaped meshes of linear triangles, finite differences can be applied when the mesh elements are aligned along the x and y axes with even spacing. In the more general case, the more general expressions below can be used. These expressions for a general element are equivalent to the finite differences expressions when the element is axis aligned.

If the surface elements are modelled as piecewise linear triangles, the extraction of the constant slope within an element is straightforward. In the linear triangle case, the surface is modelled as:

$$z ( x , y ) = {[ \begin{matrix}x & y & 1\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} [ \begin{matrix}{z}_{i} \\ {z}_{j} \\ {z}_{k}\end{matrix} ] \qquad Equation 10$$

So the slopes in x and y are:

$$\begin{matrix}\frac{\partial z ( x , y )}{\partial x} = {[ \begin{matrix}1 & 0 & 0\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} [ \begin{matrix}{z}_{i} \\ {z}_{j} \\ {z}_{k}\end{matrix} ] & Equation 11 \\ \frac{\partial z ( x , y )}{\partial y} = {[ \begin{matrix}0 & 1 & 0\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} [ \begin{matrix}{z}_{i} \\ {z}_{j} \\ {z}_{k}\end{matrix} ] & Equation 12\end{matrix}$$

These yield expressions for Hₛₗₒₚₑ:

$${H}_{slopex} = {[ \begin{matrix}1 & 0 & 0\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} \\ {H}_{slopey} = {[ \begin{matrix}0 & 1 & 0\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} \qquad Equation 13$$

The terrain smoothness information matrix is given by:

$$\begin{matrix}{Y}_{slope}^{′} = {H}_{slope}^{T} {R}_{slope}^{- 1} {H}_{slope} & Equation 14 \\ {Y}_{slope} = {\sum }_{d = x , y} {\sum }_{i} {H}_{slope d i}^{T} {R}_{sope d i}^{- 1} {H}_{slope d i} & Equation 15\end{matrix}$$

Where the slope is taken in directions d=x and y, over all elements i.

3.3.2. Curvature Model:

The curvature model requires constructing H_{curv} where H_{curv} \hat{f} extracts a stacked vector of all the individual second derivatives of the terrain surface f with respect to both x and y at each mesh point i:

$${H}_{curv} \hat{f} = {⋃}_{i} {[ \frac{{\partial }^{2} {f}_{i}}{\partial {x}^{2}} \frac{{\partial }^{2} {f}_{i}}{\partial {y}^{2}} ]}^{T} \qquad Equation 16$$

In the present embodiment, this also uses a finite difference expression for the second derivatives, based on a regular grid. For example, on a segment of terrain with elevations yₖ₋₁ at xₖ₋₁ through to yₖ₊₁ at xₖ₊₁, the finite difference second-derivative is given by:

$$\frac{{\partial }^{2} y}{{\partial }^{2} x} \approx \frac{1}{{h}^{2}} {y}_{k - 1} - 2 {y}_{k} + {y}_{k + 1} \\ {H}_{curv} = \frac{1}{{h}^{2}} [ \begin{matrix}0 & … & - 1 & 2 & - 1 & … & 0\end{matrix} ] \qquad Equation 17$$

Finally, the terrain smoothness information matrix is given by:

Y_{curv}=H_{curv}^{T}R_{curv}⁻¹H_{curv} Equation 18

Where R^{curv} is a model tuning parameter expressing the modelled covariance in the terrain curvature. As for Rₛₗₒₚₑ, R_{curv} is a control parameter for the model. Large R_{curv} corresponds to very rough terrain, small R_{curv} corresponds to very smooth and evenly-sloped terrain.

For general shaped meshes of linear triangles, the modelled linear triangular elements have no inherent curvature as single elements. Curvature must instead be considered across (at least) an edge between two triangular elements. However, without any guaranteed regular spacing or orientation between adjacent elements, it is necessary to carefully define an appropriate curvature expression. The approach taken is based on extracting the curvature of some quadratic.

The preferred approach is to use a quadratic fit to 4 vertices of a pair of triangles. This uses a particular quadratic consisting of a linear term parallel to the edge, linear and quadratic terms perpendicular to the edge and a constant elevation term:

$$z ( p , e ) = {\sum }_{n = ( i , a , b , f )} {z}_{n} ( {A}_{n} {p}^{2} + {B}_{n} p + {C}_{n} e + {D}_{n} ) \qquad Equation 19$$

This has just one bending component in a direction perpendicular to the edge, (indicating the curvature as required) and is also defined exactly by the 4 vertices. The coordinates (p, e) are obtained from coordinates (x, y) by a 2D rotation where p is the direction perpendicular to the edge.

$$\frac{{\partial }^{2} z ( p , e )}{\partial {p}^{2}} = {[ \begin{matrix}1 & 0 & 0 & 0\end{matrix} ] [ \begin{matrix}{p}_{a}^{2} & {p}_{a} & {e}_{a} & 1 \\ {p}_{b}^{2} & {p}_{b} & {e}_{b} & 1 \\ {p}_{i}^{2} & {p}_{i} & {e}_{i} & 1 \\ {p}_{f}^{2} & {p}_{f} & {e}_{f} & 1\end{matrix} ]}^{- 1} [ \begin{matrix}{z}_{a} \\ {z}_{b} \\ {z}_{i} \\ {z}_{f}\end{matrix} ] \qquad Equation 20$$

H_{curv} is then given by:

$${H}_{curv} = {[ \begin{matrix}1 & 0 & 0 & 0\end{matrix} ] [ \begin{matrix}{p}_{a}^{2} & {p}_{a} & {e}_{a} & 1 \\ {p}_{b}^{2} & {p}_{b} & {e}_{b} & 1 \\ {p}_{i}^{2} & {p}_{i} & {e}_{f} & 1 \\ {p}_{f}^{2} & {p}_{f} & {e}_{f} & 1\end{matrix} ]}^{- 1} \qquad Equation 21$$

### 3.3.3. Combining the Zero-Derivative and Zero-Slope Models:

The additive fusion property of the information form allows the creation of a blended model combining the zero-derivative and zero-slope models. The combination is controlled by the parameters Rₛₗₒₚₑ and R_{curv}:

$$\begin{matrix}Y = {Y}_{slope} + {Y}_{curv} \\ = {H}_{slope}^{T} {R}_{slope}^{- 1} {H}_{slope} + {H}_{curv}^{T} {R}_{curv}^{- 1} {H}_{curv}\end{matrix} \qquad Equation 22$$

This matrix Y then represents the terrain smoothness prior information, and is ready for the fusion of observations.

### 3.3.4. Setting Slope or Curvature at Particular Values

In some embodiments, the slope and/or the curvature may be set at particular values. For example, if it is known that a domain of interest has a particular slope and/or curvature at a particular location or if an estimate of these variables had been obtained, then this information may be included in the smoothness information model.

In the model, Yₛₗₒₚₑ=Hₛₗₒₚₑ^{T}Rₛₗₒₚₑ⁻¹Hₛₗₒₚₑ. The known or assumed (possibly zero) value for the slope Zₛₗₒₚₑ, is incorporated as:

yₛₗₒₚₑ=Hₛₗₒₚₑ^{T}Rₛₗₒₚₑ⁻¹Zₛₗₒₚₑ Equation 23

Similarly for Y_{curv}=H_{curv}^{T}R_{curv}⁻¹H_{curv}:

y_{curv}=H_{curv}^{T}R_{curv}⁻¹Z_{curv} Equation 24

where Z_{curv} is again the known or assumed (possibly zero) value for the curvature.

The R⁻¹ parameters represent the confidence in the supplied Z values. Both the R⁻¹ values and the Z values can be specified with different values at different positions,

### 3.4. Fusion of Observations

Referring to FIG. 8 again, step 806 of the GP Information method is to build the information matrix and vector representation of the observations. Fusion is required in order to achieve large area coverage by overlaying multiple scans. Fusion is required in order to use multiple different sensors, such as laser and GPS, with differing noise and sample density properties and still obtain a single representation for the posterior estimate. The aim of information fusion, is to obtain a single representation from multiple sources of observed data. The aim is that the fused representation should be higher quality (more accurate and less uncertain) than the single observation sources. Information fusion aims to achieve such a fused representation using as small a data size as possible.

In general, given a prior information matrix, Y and vector y, the posterior information after fusing an additional linear observation is given by:

Y⁺=Y+H^{T}R⁻¹H

y⁺=y+H^{T}R⁻¹z Equation 25

For a linear observation of the form z=Hx+w, for white Gaussian noise, w with covariance R. z is the raw observed data, which for a two-dimensional mesh has a specific location (x, y) within the spatial mesh described above.

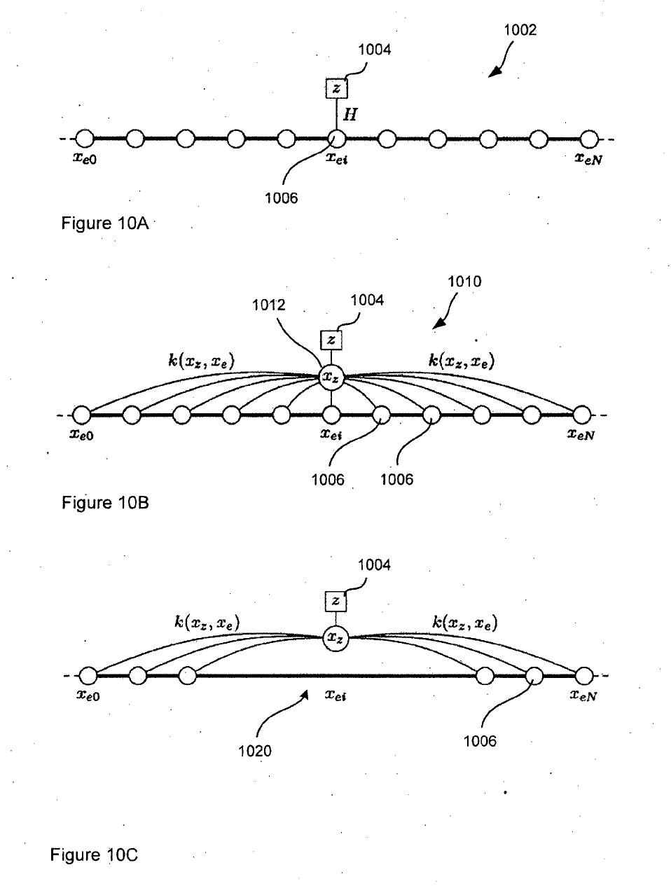

Referring to FIG. 10, in conventional estimation, observations are related to states through an H matrix, usually a sparse model 1002 relating the observation 1004 directly to just one or a few states 1006. This is illustrated in FIG. 10A. By contrast, in the outcome 1010 of the GP Covariance method illustrated in FIG. 10B, the observation 1004 is linked to states 1006 through the covariance function 1012, usually a dense model relating the observation 1004 to several or all of the states 1006. However, when an observation occurs very close to an existing evaluation state, such a dense model is redundant because the covariance entries mapping x_{z} to each xₑ will be nearly identical to the covariance entries mapping the nearby x_{ci} to each other xₑ. On the other hand, in the GP Covariance method, an observation 1004 can be placed in a region 1020 empty of evaluation states as shown in FIG. 10C.

Focusing on observation matrix H, the simple case is when an observation occurs exactly on an evaluation point (i.e. a point of intersection in the spatial mesh). FIG. 10A shows an observation occurring exactly on a grid point. For the “on-grid” case, each row of H is a row with a single 1 corresponding to the observed state.

H=[ . . . 010 . . . ] Equation 26

However, in general, the observations will not align with grid points. The proximity of observations to grid points depends on the grid density. If observations are required to be very close to grid points, this effectively dictates that a very fine grid mesh must be used.

In some embodiments, if a sufficiently fine grid mesh is used, each observation may be approximated as having been made at the location of the nearest grid point. In these embodiments, H remains as shown above.

In alternative embodiments, a finite element inspired trial function representation (described above with reference to FIG. 7) allows a representation of the properties of the terrain in between the mesh points, which enables fusion of observations which do not lie exactly on a grid point. No approximation is made in how observations are fused into the trial function representation (but the trial function, representation is itself an approximation of the continuous space).

H is built as follows. With u(x) approximated by the trial functions,

$$u ( x ) \approx {\sum }_{i} {U}_{i} {V}_{i} ( x ) \text{:} {z}_{i} = {\sum }_{j} {U}_{j} {V}_{j} ( {x}_{i} ) + w \qquad Equation 27$$

The observation is written as an operator Hᵢ which maps U into zᵢ:

$$\begin{matrix}\begin{matrix}{z}_{i} = {H}_{i} U + w \\ = {[ \begin{matrix}{V}_{0} ( {x}_{i} ) & … & {V}_{{N}_{t}} ( {x}_{i} )\end{matrix} ] [ \begin{matrix}{U}_{0} & … & {U}_{{N}_{t}}\end{matrix} ]}^{T} + w\end{matrix} & Equation 28 \\ {H}_{i} = [ \begin{matrix}{V}_{0} ( {x}_{i} ) & … & {V}_{{N}_{t}} ( {x}_{i} )\end{matrix} ] & \end{matrix}$$

Thus when xᵢ exists between grid points, this shows how to weight the observation onto various U unknowns.

In some embodiments the trial functions are non-zero only in small regions, in which case each row of H is sparse with only a few non-zeros:

H=[0 . . . Vₐ(xᵢ)V_{b}(xᵢ)V_{c}(xᵢ) . . . 0] Equation 29

For which the information representation is:

Yᵢ=Hᵢ^{T}Rᵢ⁻¹Hᵢ

yᵢ=Hᵢ^{T}Rᵢ⁻¹zᵢ Equation 30

For overlapping trial functions the observation information adds information regarding the sum of the overlapping trial functions at the observation point, which cross-couples any overlapping trial functions at the observation point. For an observation lying exactly on a grid point, xₑⱼ, Vᵢ(xₑⱼ)=0 for i≈j and Vⱼ(xₑⱼ)=1. So the observation Hⱼ matrix returns exactly to the earlier description of the “on-grid” case (being a single 1 in a row of zeros).

More specifically, the surface may be modelled as a piecewise polynomial of spatial position. The piecewise polynomial may comprise, for example, a linear function, a quadratic function, a bilinear function, a higher order function and/or other polynomial function.

### 3.4.1. Using a Linear Function

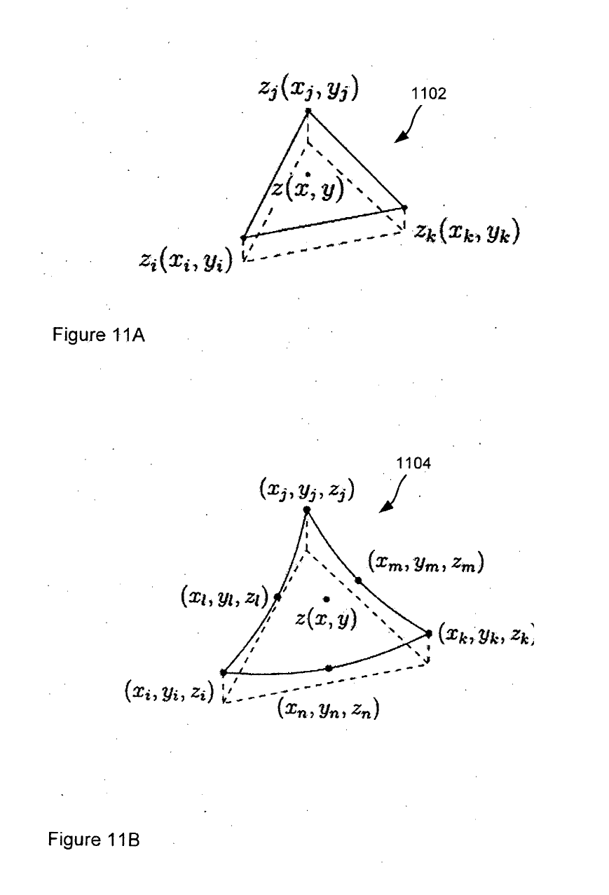

FIG. 11A is a representation of the terrain surface within a linear triangular element 1102. The piecewise linear polynomial is given as follows:

z(x,y)=Ax+By+C Equation 31

The coefficients are defined by requiring the surface to pass through the triangle's vertices: z(x_{i*}, yᵢ)=zᵢ, where zᵢ is the vertex elevation (the unknown state variable) and xᵢ, yᵢ are the known vertex positions, for each vertex i in the triangle. As a result, the surface elevation z as a function of position, within a triangle with vertices i, j, k is given by:

$$z ( x , y ) = {[ \begin{matrix}x & y & 1\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} [ \begin{matrix}{z}_{i} \\ {z}_{j} \\ {z}_{k}\end{matrix} ] \qquad Equation 32$$

So the expression for H_{obs} becomes:

$${H}_{obs} = {[ \begin{matrix}x & y & 1\end{matrix} ] [ \begin{matrix}{x}_{i} & {y}_{i} & 1 \\ {x}_{j} & {y}_{j} & 1 \\ {x}_{k} & {y}_{k} & 1\end{matrix} ]}^{- 1} \qquad Equation 33$$

### 3.4.2. Using a Quadratic Function

FIG. 11B is a representation of the terrain surface within a quadratic triangular element 1104. The piecewise quadratic polynomial is given as follows:

$$\begin{matrix}z ( x , y ) = Ax + {Bx}^{2} + Cy + {Dy}^{2} + Exy + 1 & Equation 34 \\ z ( x , y ) = {[ \begin{matrix}x & {x}^{2} & y & {y}^{2} & xy & 1\end{matrix} ] [ \begin{matrix}{x}_{i} & {x}_{i}^{2} & {y}_{i} & {y}_{i}^{2} & {x}_{i} {y}_{i} & 1 \\ {x}_{j} & {x}_{j}^{2} & {y}_{j} & {y}_{j}^{2} & {x}_{j} {y}_{j} & 1 \\ {x}_{k} & {x}_{k}^{2} & {y}_{k} & {y}_{k}^{2} & {x}_{k} {y}_{k} & 1 \\ {x}_{l} & {x}_{l}^{2} & {y}_{l} & {y}_{l}^{2} & {x}_{l} {y}_{l} & 1 \\ {x}_{m} & {x}_{m}^{2} & {y}_{m} & {y}_{m}^{2} & {x}_{m} {y}_{m} & 1 \\ {x}_{n} & {x}_{n}^{2} & {y}_{n} & {y}_{n}^{2} & {x}_{n} {y}_{n} & 1\end{matrix} ]}^{- 1} [ \begin{matrix}{z}_{i} \\ {z}_{j} \\ {z}_{k} \\ {z}_{l} \\ {z}_{m} \\ {z}_{n}\end{matrix} ] & Equation 35\end{matrix}$$

So the expression of H_{obs} becomes:

$$\begin{matrix}{H}_{obs} = z ( x , y ) \\ = [ \begin{matrix}x & {x}^{2} & y & {y}^{2} & xy & 1\end{matrix} ] \\ {[ \begin{matrix}{x}_{i} & {x}_{i}^{2} & {y}_{i} & {y}_{i}^{2} & {x}_{i} {y}_{i} & 1 \\ {x}_{j} & {x}_{j}^{2} & {y}_{j} & {y}_{j}^{2} & {x}_{j} {y}_{j} & 1 \\ {x}_{k} & {x}_{k}^{2} & {y}_{k} & {y}_{k}^{2} & {x}_{k} {y}_{k} & 1 \\ {x}_{l} & {x}_{l}^{2} & {y}_{l} & {y}_{l}^{2} & {x}_{l} {y}_{l} & 1 \\ {x}_{m} & {x}_{m}^{2} & {y}_{m} & {y}_{m}^{2} & {x}_{m} {y}_{m} & 1 \\ {x}_{n} & {x}_{n}^{2} & {y}_{n} & {y}_{n}^{2} & {x}_{n} {y}_{n} & 1\end{matrix} ]}^{- 1}\end{matrix} \qquad Equation 36$$

### 3.4.3. Multiple Dataset Fusion

The additive property of the information matrices under new observations means that fusion of further observations is straightforward. In fact, in the GP Information method there is no distinction between the fusion of multiple datasets and the fusion of single observations within a dataset.

The fusion of observation information is a matrix and vector addition, and therefore it is independent of the order of fusion and independent of how the observations are (arbitrarily) clustered into “datasets”.

The smoothness is a property of the terrain itself, and not of the observations (or of a particular dataset of observations). In other words, the terrain smoothness information is not counted more than once. To estimate the terrain given dataset A, solve for X, as follows:

Y_{A}=Y_{obs dataset A}+Yₛₘₒₒₜₕₙₑₛₛ

yₐ=y_{obs dataset A}

Y_{A}xₐ=yₐ Equation 37

To estimate the terrain given datasets A and B₁ solve for x_{b} as follows:

Y_{AB}=Y_{obs dataset A}+Y_{obs dataset B}+Yₛₘₒₒₜₕₙₑₛₛ

y_{ab}=y_{obs dataset A}+y_{obs dataset B}

Y_{AB}x_{ab}=y_{ab} Equation 38

To fuse a whole series of observation datasets, a “running sum” is performed of all the observation datasets into a single Y_{obs} as follows:

Initialise: Y_{obs}=0
Yobs=0

For each observation dataset is Y_{obs}+=Yi
y_{obs}+=yi

Add the smoothness model: Y=Y_{obs}+Yₛₘₒₒₜₕₙₑₛₛ
y=y_{obs}

Finally, solve for x: Yx=y

The fusion of observations concept is also illustrated in FIG. 12. FIG. 12 is an illustration of the fusion of observations 1201 into a triangularised mesh 1202. Observations can fall anywhere within a given triangle in the mesh. Each observation is fused in by adding a 3×3 block into the existing system information matrix and 3×1 entries in the information vector. In this way, a large number of observations 1201 (individually or in dataset blocks) can be fused into the mesh representation and still maintain approximately the same constant representation complexity as determined by the choice of mesh resolution.

The advantages provided by the way that fusion is performed in the GP Information method are related to the representation of the information matrix and vector in the evaluation grid and that additive fusion of observations as sparse additions into the existing information matrix is performed. These fusion properties are important for scale implementation of terrain geometry estimation in MPC. This is in contrast to the GP Covariance method of fusion where the raw observations are appended in a manner that grows linearly with each additional observation dataset.

### 3.5. Solving for the Estimate and Covariance

Referring to FIG. 8, at step 808 a large, sparse matrix Y and a sparse vector y has been constructed. The estimated terrain surface is recovered by solving for x:

Yx=y Equation 39

The information matrix, Y, is sparse, symmetric, and can also be guaranteed to be positive definite provided there is at least one observation. To solve this standard methods from linear algebra can be used, paying attention to the sparsity structure of the system. A conventional method is to perform a positive-definite, symmetric factorisation for example: Cholesky or LDL factorisation.

For notational purposes factorisation and solution is described.

Yx=y is solved by first decomposing Y into a factorised form:

Y=LDL^{T} Equation 40

Where L is lower triangular, D is diagonal. For the Cholesky factorisation, D is the identity matrix and hence drops out of the operations. The LDL notation is adopted in the description below.

3.5.1. Factorisation

The L factor is obtained by factorisation of the information matrix. The factorisation corresponds to Gaussian elimination, meaning that the factorisation process steps through the system of variables one at a time, modifying Y into the corresponding entries in L. The most important aspect of this process is that the computational complexity of the result depends critically on the ordering with which the factorisation operates on the matrix.

3.5.2. Solution for the Estimate

The estimated terrain surface is recovered via solving:

x=(L^{T}\(D\(L\b))) Equation 41

Where the backslash operations (\) indicate linear systems solves in the L,D and L^{T} systems. Each solve in L or L^{T} is a sparse linear triangular solve, which is a key solving operation implemented in sparse linear systems packages. The solve in D is a very simple diagonal solve which corresponds to a simple scalar division on each variable.

3.5.3. Solution for the Covariance

The terrain uncertainty P is extracted from the inverse of the information matrix:

P=Y⁻¹ Equation 42

However, this equation may not be feasible to implement literally, since P will be fully dense, and the GP Information method may be used to build terrain models larger than those which are feasible to represent with fully dense covariance matrices.

The full, dense covariance matrix, and the arbitrary cross-covariances Pij are not however required. Extraction of the covariance is not required for estimation of the estimate, and is not required for fusion of further estimates in the information matrix. Instead, a visualisation of terrain estimate uncertainty is formed from the diagonals of P, corresponding to the set of the marginal uncertainty at each evaluation point.

The entries of P corresponding to the nonzeros of L (which always includes the diagonal) can be extracted relatively efficiently. This technique is known as sparse approximate inversion, Takahashi inversion or simply “computing selected elements of the covariance matrix”. Takahashi inversion extracts the covariance, P, from the L and D factors by the following recursion, starting from the lower right entry, i=n:

Pᵢⱼ=−Lᵤ⁻¹(Σₖ₌ᵢ₊₁ⁿLₖⱼPₖⱼ)

Pᵢᵢ=(Lᵢᵢ⁻¹Dᵢ⁻¹−Σₖ₌ᵢ₊₁ⁿPᵢⱼLₖᵢ)Lᵢᵢ⁻¹ Equation 43

The method is described in more detail for example in B. Triggs, P. McLauchlan, R. Hartley, and A. Fitzgibbon, “Bundle adjustment—a modern synthesis,” in Vision Algorithms: Theory and Practice, ser. LNCS, W. Triggs, A. Zisserman, and R. Szeliski, Eds. Springer Verlag, 2000, pp. 298-375.

3.6. Pre-Computable Objects

Some steps of the GP Information modelling process are independent of the observations, instead depending only on the spatial mesh model. These “pre-computable objects” can be used to, speed up the online calculations.

The following steps can be pre-computed independent of the observations:
1. Precompute the spatial mesh model.
2. Precompute the sparse model (H) and Information (H^{T}R⁻¹H) matrices for the slope and curvature models.
3. Precompute an optimised ordering of the states for the factorisation of the information matrix.
4. Precompute the sparsity pattern and storage requirements for the LDL or Cholesky factorisation.

Similarly, different parts of the model are required for solving as opposed to contributing information (sensing). The smoothness model and factorisation capabilities are not required on sensing-only platforms. To contribute sensor observations, the following are required on the sensing platform:
The spatial mesh model
The ordering of the states

To perform solving operations, the following are required on the platform:
The spatial mesh model
The slope and curvature model information matrices
The factorisation sparsity pattern.

The above description has discussed the GP Information terrain estimation and fusion method, with an explanation of the main steps in the formulation and solving process, consisting of building the spatial model, building the terrain smoothness prior information matrix, fusion of observations and finally solving for the estimate and covariance. While this example describes how the GP Information method may be used to estimate the terrain, the GP Information method may be modified to map geological, mechanical or chemical properties including but not limited to: ore grade or mineralogy grades generally (e.g. % of iron), moisture/water content, density, hardness etc. The GP Information method may be modified to map other spatial fields, based on observations of variables in the environmental sciences, hydrology, economics and robotics fields.

The non-reverting property of the estimation method described herein is obtained by using a smoothness information model to ‘spread’ the information from locations which are observed to all other locations. If the system performs the steps for the preparation of the mesh representation and the fusion of observations, the resulting information matrix system Y_{obs}x=y_{obs} (the subscript ‘obs’ referring to observed data) will not be solvable in regions where any mesh element has not been observed.

The primary method described here is to solve (Y_{obs}+Yₛₘₒₒₜₕ) x=(y_{obs}), where Yₛₘₒₒₜₕ obtained from the information smoothing model described previously. The smoothness model Yₛₘₒₒₜₕ is non-reverting because if it is marginalised into any of its scalar components, the result is zero, meaning that the model adds zero information to any individual component (it only adds information in relative terms between components). Y_{marg}=Y_{gg}−Y_{rg}(Yᵣᵣ)⁻¹Y_{gr}==0 (for any index g, where r is all other indices excluding g). A more general definition for the smoothness information could also be: Yₛₘₒₒₜₕ comes from the sum of a series of smoothness models H′*R⁻¹*H. Each row of each H sums to zero.

The GP Information method is also advantageous because it is able to support an efficient multi-source fusion algorithm. Efficient fusion is useful in a distributed operation because it can enable quick sensing and update of maps. The GP Information method is advantageous because it natively support multiple dataset fusion, leading to its usage for distributed multi-platform operation.

### 4. Example of Results

An example of how the GP Information method can be used for fusion of mine site terrain datasets is described below. Raw GPS and laser observations were taken of the Tom Price mine in Western Australia, Australia.

4.1. Visual Map Results

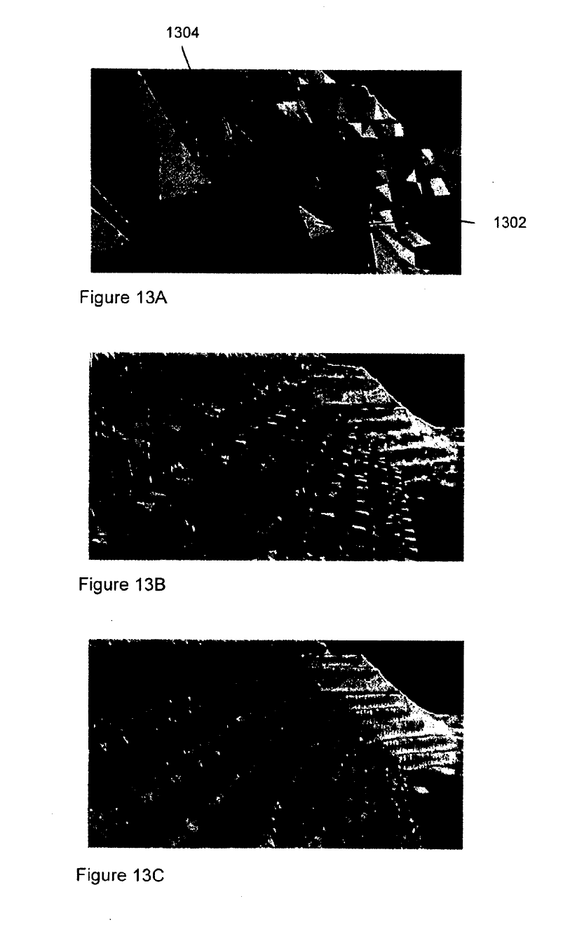

FIG. 13 compares GPS Delaunay surface triangulations from the raw GPS data (FIG. 13A) and the raw laser data (FIG. 13B) to the fused output of the GP Information terrain estimate (FIG. 13C). The view focuses on the mine side benches. It will be understood that Delaunay triangulation refers to the subdivision of the relevant surface into triangles for computational purposes, and that this type of triangulation results in no points being inside the circumcircle of each triangle.

Referring to FIG. 13A, the GPS data are sparsely scattered, so the resulting Delaunay surfaces have very large facets which occasionally show shapes which are not representative of the terrain, simply due to the choice of points used for triangulation, e.g.: some GPS Delaunay facets completely miss the toe of the bench (1302, 1304).

Referring to FIG. 13B, the laser data are more dense but are only available for the bench faces. As a result, the Delaunay triangulation has larger, long and thin facets on the bench face.

By comparison the GP Information terrain estimate (FIG. 13C) shows a good reconstruction of the terrain features, with smooth and consistent surface estimates in between available observation data. The GP Information terrain estimate also benefits from the fused combination of 2 laser scans and GPS data.

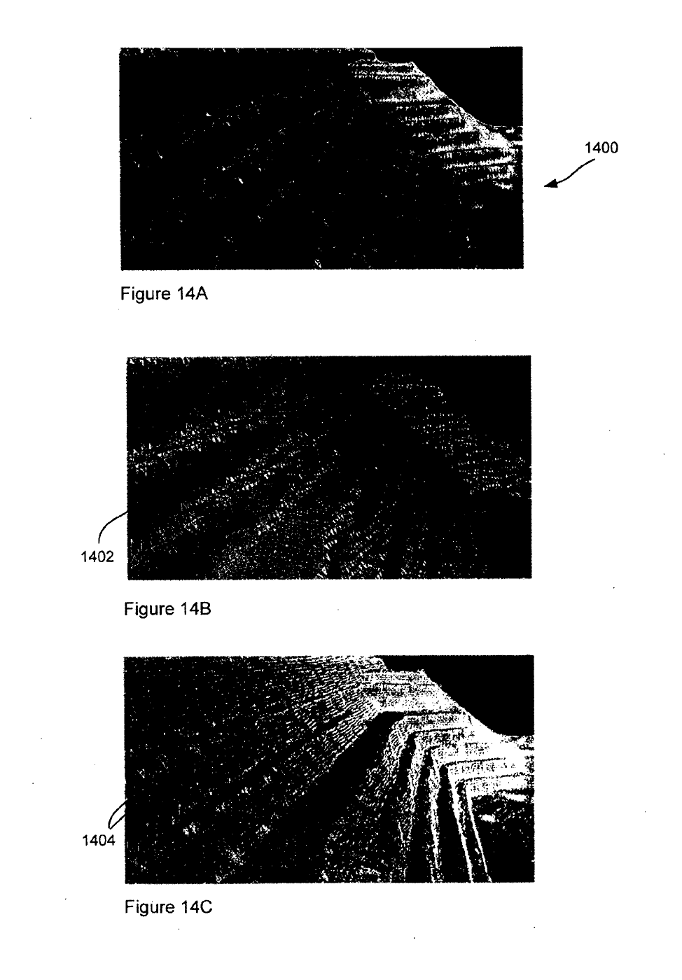

FIG. 14 shows the GP Information estimate 1400 (FIG. 14A), together with the triangulated mesh 1402 used to discretise the space (FIG. 14B) and showing the overlaid observation data 1404 (FIG. 14C). The internal mesh 1402 shows how the GP Information model discretises the space.

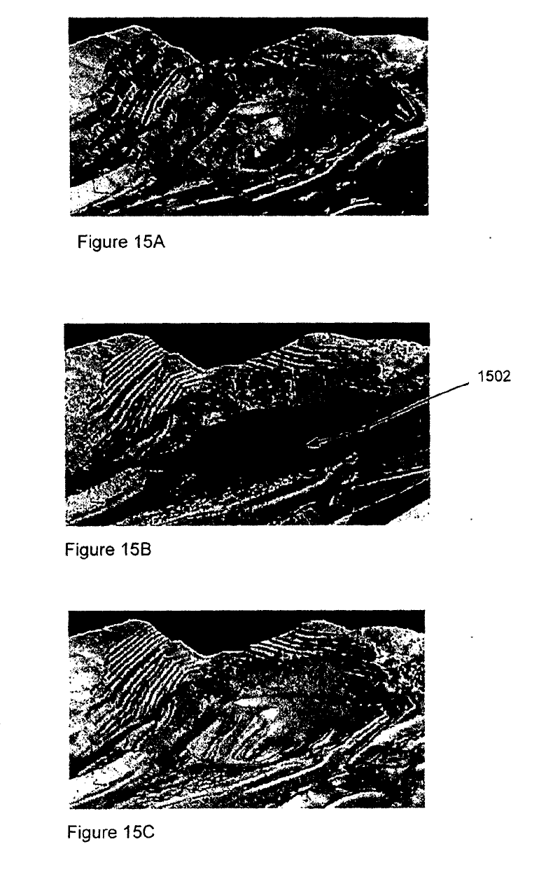

FIG. 15 shows the same results shown in FIGS. 13 and 14 but on a broader perspective of the mine site. In the broader view it is clear how large gaps in the laser data (see FIG. 15B) severely affect the laser Delaunay triangulation surface, for example M the central region 1502.

4.2. Data Size Results for Multiple Dataset Fusion

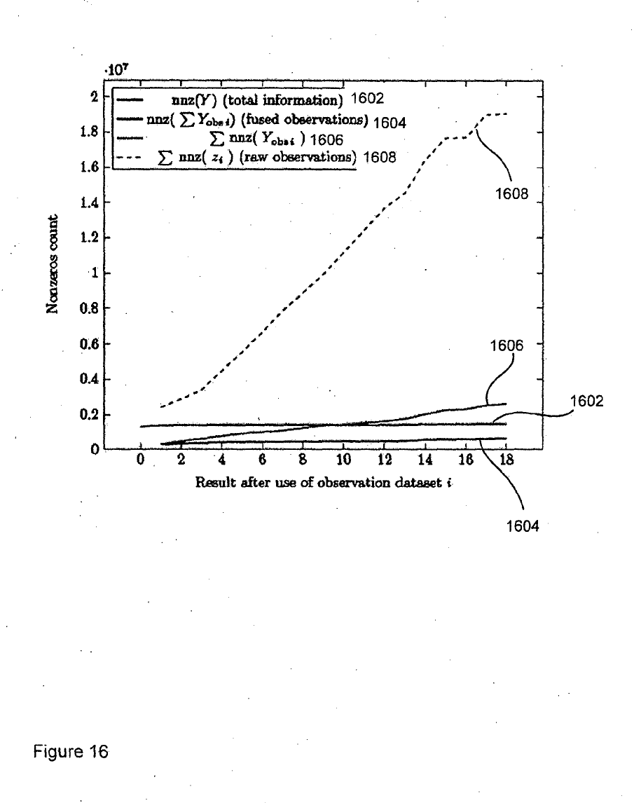

It is beneficial in a distributed and large scale implementation of terrain estimation to reduce the data size by using the GP Information fusion operations. The number of nonzeros (nnz) are reflective of the complexity required to store, communicate or solve the system. On the other hand, in this regard, the matrix dimensions are less significant due to the very sparse nature of the matrices. FIG. 16 shows the number of nonzero results for successive fusion of datasets (compared to no fusion). Each entry has the result after using another dataset.
nnz(ΣY) 1602 is the number of nonzeros in the (upper triangle of) the fused Y matrix including the smoothness model. This is representative of the size of the system which must be solved for the estimation process.
nnz(ΣY_{obsi}) 1604 is the number of nonzeros in the (upper triangle of) the fused sum of observation information matrices (ie: excluding the smoothness information). This is representative of the size of information which would need to be communicated if the fused dataset was transmitted. It is smaller than nnz(Y) because the smoothness information can be discarded before transmission:
Σnnz(Y_{obsi}) 1606 is the result for the sum of nonzero counts in the observation information matrices. This is representative of the effective size if observation datasets never overlapped each other.
Finally, Σnnz(zᵢ) 1608 is the cumulative size of raw observation data points (x, y, z). This is representative of the storage and/or communication required in order to manipulate the raw observation data without any fusion.

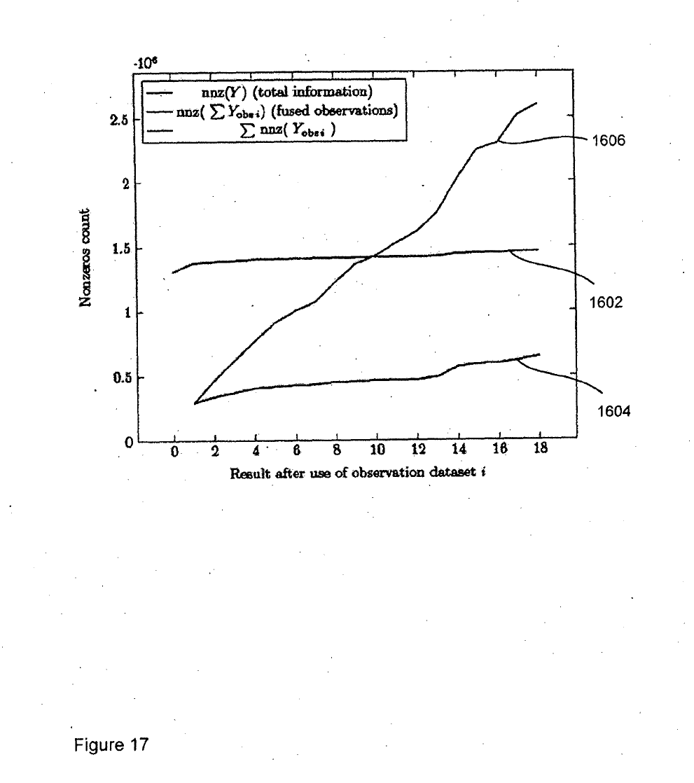

FIG. 17 excludes Σnnz(zᵢ) to focus on the other plots. This shows how the total information nnz(Y) (observations plus smoothness model) remains roughly constant in data size, despite the fusion of 18 datasets of observations. FIG. 17 also shows that the sum of all the observation information Σnnz(Y_{obsi}) is much more compact than would be obtained if no overlap in the observation datasets occurred (as represented by Σnnz(Y_{obsi})).

Table 1 below lists the results in numerical format.

TABLE 1

| | | nnz(ΣY_{obsi}) | | |
|---|---|---|---|---|
| n | nnz(Y) (×10⁶⁾ | (×10⁵) | Σnnz(Y_{obsi}) (×10⁶) | Σnnz(zᵢ) (×10⁷) |
| 0 | 1.31 | | | |
| 1 | 1.37 | 2.96 | 0.30 | 0.24 |
| 2 | 1.39 | 3.43 | 0.47 | 0.29 |
| 3 | 1.39 | 3.75 | 0.62 | 0.34 |
| 4 | 1.40 | 4.08 | 0.77 | 0.45 |
| 5 | 1.40 | 4.19 | 0.91 | 0.55 |
| 6 | 1.41 | 4.28 | 1.00 | 0.66 |
| 7 | 1.41 | 4.34 | 1.07 | 0.78 |
| 8 | 1.41 | 4.53 | 1.22 | 0.89 |
| 9 | 1.41 | 4.56 | 1.37 | 0.99 |
| 10 | 1.42 | 4.65 | 1.43 | 1.12 |
| 11 | 1.42 | 4.66 | 1.53 | 1.24 |
| 12 | 1.42 | 4.68 | 1.61 | 1.37 |
| 13 | 1.42 | 4.92 | 1.76 | 1.46 |
| 14 | 1.44 | 5.68 | 2.02 | 1.64 |
| 15 | 1.45 | 5.88 | 2.25 | 1.77 |
| 16 | 1.45 | 5.95 | 2.30 | 1.77 |
| 17 | 1.45 | 6.15 | 2.51 | 1.90 |
| 18 | 1.45 | 6.46 | 2.60 | 1.90 |

These results show that the size of the systems to be solved for the terrain estimate is roughly constant, for a given area of terrain at a given resolution, independent of the number or size of datasets which are fused into that area.

The fusion process is effective in reducing the data size required for storage and communication of the fused results, especially compared to the size of the raw observation data. The data size required to be communicated between platforms is roughly proportional to the area covered by the union of the observations fused in.

### 5. Alternative Non-Reverting Embodiments

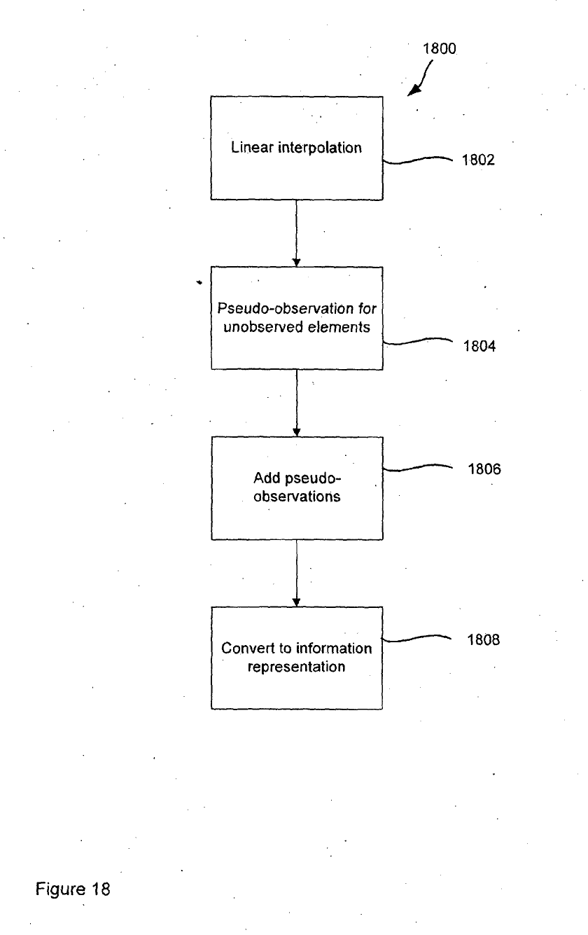

Another method 1700 to obtain a non-reverting estimate method is shown in FIG. 18 and has the following steps:

1. Run a linear interpolation (1D) or Delaunay triangulation (in case of >2D) of the input observations at step 1702.

2. At step 1704 obtain a pseudo-observation for the element centre from the linear interpolation or Delaunay triangulation which is a linear interpolation of nearby observation points for each unobserved element in the mesh.

3. Add these pseudo-observations at step 1706 in the same manner as genuine observations, but with a very small R_{obs}⁻¹, since they are not independent observations.

4. At step 1708 convert the combined observations and pseudo-observations into the information representations Y and y so as to enable a computational problem of the form Yx=y to be solved as described herein above.

This method still enables fusing of additional observations into previous observations and the fusing of multiple observation sets from distributed physical components as described for the information representation incorporating a smoothness information model. Variations to this method may use other interpolation techniques.

For at least some applications, this alternative method has some disadvantages compared to the information smoothing model, including: The estimate at unobserved elements will be the pseudo-observations used, rather than smoothly transitioned estimates; and the uncertainty at the unobserved elements will be R_{obs} of the pseudo-observations, rather than a smoothly transitioning uncertainty related to the distance from observations.

In still other embodiments, a combination of interpolation and use of the smoothness model may be used. In these embodiments one or more, but not all of the unobserved elements in the mesh are identified by interpolation and the information smoothness model left to deal with the remaining unobserved elements.

As used herein the words “estimate” and “estimation” have been used interchangeably.

It will be understood that the invention disclosed and defined in this specification extends to all alternative combinations of two or more of the individual features mentioned or evident from the text or drawings. All of these different combinations constitute various alternative aspects of the invention.

1. (canceled)

2. A method of spatial field estimation from input data from a domain of interest, the method comprising:
defining a spatial mesh of positions over the domain of interest;
defining a smoothness information model defined with respect to the spatial mesh to form an information matrix Y₁ and vector y₁;
defining an information representation of the input data, the information representation comprising an information matrix Y_{obs} and vector y, both defined relative to the spatial mesh;
through an additive function fusing the smoothness information model with the information representation of the input data to form an information matrix Y and vector y;
in a computational system solving for x in Yx=y, wherein x represents the spatial field estimation.

3. The method of claim 2, further comprising:
associating with each spatial mesh position a combination of discrete trial functions with variable coefficients;
for each instance of input data, incorporating into said information representation a mapping of the input data onto said coefficients.

4. The method of claim 2 wherein the smoothness information model is defined independently of the input data.

5. The method of claim 2, wherein the input data comprises spatial field observations and wherein the method further comprising selecting a density of the spatial mesh to be of the same order of magnitude as a density of the spatial field observations.

6. The method of claim 2, wherein the smoothness information model comprises information regarding slope.

7. The method of claim 2, wherein the smoothness information model comprises information regarding curvature.

8. The method of claim 2, wherein the smoothness information model comprises both slope and curvature.

9. The method of claim 2, wherein spatial field uncertainty is represented by the smoothness information model and the information representation of the input data and wherein solving Yx=y comprises computationally determining the spatial field estimation and computationally determining P=inverse(Y) for a covariance (P) for the spatial field estimation.

10. A method of spatial field estimation of a domain of interest, the method comprising:
defining a first information representation of first input data representative of the domain of interest, the first information representation comprising an information matrix Y_{obsA} and vector yₐ, both defined relative to a spatial mesh of positions over the domain of interest;
receiving further input data;
defining a further information representation, the information representation comprising an information matrix Y_{obsB} and vector y_{b}, both defined relative to the spatial mesh of positions over the domain of interest;
performing an additive function of the further information representation with the first information representation and a smoothness information model to provide a fused information representation, the fused information representation comprising information matrix Y and vector y;
in a computational system solving Yx=y, wherein x represents the spatial field.

11. The method of claim 10, further comprising computing a first spatial field estimation based on the first input data and outputting the first spatial field estimation, wherein the first spatial field estimation is computed prior to receipt of the further input data.

12. The method of claim 11, wherein the first spatial field estimation is computed by a first computational system in a hierarchy of computational systems and the second spatial field estimation is computed by a second computational system in the hierarchy of computational systems.

13. The method of claim 11 wherein the second computational system is located higher in the hierarchy than the first computational system.

14. The method of claim 10, wherein the first input data is from a first sensor and the further input data is from a second sensor, different from the first sensor.

15. The method of claim 13, wherein the first sensor and second sensor are physically separated within the domain of interest.

16. A method of spatial field estimation from input data from a domain of interest, the method comprising:
receiving input data;
defining an information representation of the input data, the information representation comprising an information matrix Y and vector y, both defined relative to a spatial mesh of positions over the domain of interest;
in a computational system solving Yx=y, wherein x represents the spatial field estimation;
wherein the method further comprises:
modifying at least one of the input data and the information representation of the input data so that the solution to Yx=y does not revert to zero or the mean in regions of low or no input data.

17. The method of claim 2, wherein the input data comprises observations of a in surface.

18. The method of claim 17 wherein fusing comprises modelling the terrain surface as a piecewise polynomial function of spatial position, and wherein the piecewise polynomial function comprises a linear function, a quadratic function, and/or other polynomial function.

19. The method of claim 2, wherein the input data comprises ore grade observations.

20. (canceled)

21. A distributed computational system comprising a plurality of data processors, each in communication with memory comprising instructions that, when executed, cause that data processor to compute a spatial field estimation based on input data according to a method of spatial field estimation from input data from a domain of interest, the method comprising:
defining a spatial mesh of positions over the domain of interest;
defining a smoothness information model defined with respect to the spatial mesh to form an information matrix Y₁ and vector y₁;
defining an information representation of the input data, the information representation comprising an information matrix Y_{obs} and vector y, both defined relative to the spatial mesh;
through an additive function fusing the smoothness information model with the information representation of the input data to form an information matrix Y and vector y;
in a computational system solving for x in Yx=y, wherein x represents the spatial field estimation, and to output the spatial field estimation, wherein at least one of the plurality of data processors is in data communication with another of the data processors and is adapted to communicate a said information representation of input data received to the other data processor and wherein the other data processor is adapted to combine the received information representation with another information representation formed from other input data.

22. A non-transient computer program product comprising computer readable instructions, the instructions comprising:
instructions for defining an information representation of input data, the information representation comprising an information matrix Y_{obs} and vector y, both defined relative to a spatial mesh of positions over a domain of interest;
instructions for performing an additive function to fuse the information matrix Y_{obs} with a smoothness information model defined with respect to the spatial mesh to form an information matrix Y;
instructions for solving Yx=y, wherein x represents the a spatial field estimation.

23. The non-transient computer program product of claim 22 further comprising
instructions for modifying at least one of the input data and the information representation of the input data so that the solution to Yx=y does not revert to zero or the mean in regions of low or no input data.
